(19) United States
(12) Patent Application Publication
(10) Pub. No.: US 2019/0189019 A1
(43) Pub. Date: Jun. 20, 2019

(54) System and Method for Integrating Special Effects with a Text Source

(71) Applicant: Novel Effect, inc., Seattle, WA (US)

(72) Inventors: Matthew William Hammersley, Seattle, WA (US); Kevin Coulton, Seattle, WA (US)

(21) Appl. No.: 16/284,719

(22) Filed: Feb. 25, 2019

Related U.S. Application Data
(63) Continuation-in-part of application No. 15/095,753, filed on Apr. 11, 2016, now Pat. No. 10,249,205.
(60) Provisional application No. 62/172,760, filed on Jun. 8, 2015.
(60) Provisional application No. 62/264,276, filed on Dec. 7, 2015.

(51) Int. Cl. G09B 5/06; G10L 15/08; G10L 15/18; G06N 20/00

(52) U.S. Cl. CPC G09B 5/062; G10L 15/083; G10L 2015/088; G06N 20/00; G10L 15/18

(57) ABSTRACT

Systems, methods, and computer program products relate to special effects for a text source, such as a traditional paper book, e-book, mobile phone text, comic book, or any other form of pre-defined reading material, and for outputting the special effects. The special effects may be played in response to a user reading the text source aloud to enhance their enjoyment of the reading experience and provide interactivity. The special effects can be customized to the particular text source and can be synchronized to initiate the special effect in response to pre-programmed trigger phrases when reading the text source aloud.

### FIELD

Embodiments of the present disclosure relate to integrating special effects with a text source, and, in particular, with the reading of a text source.

### BACKGROUND

Generation of synchronized music and/or audible effects in combination with silent reading is described in, for example, U.S. Patent Application Publication No. 2011/0153047. Such systems, however, are dependent on use of electronic books and algorithms that synchronize a user's reading speed to the sound effects by use of a learning algorithm that times the sound effects based on the user's reading speed. Further, such systems do not provide an interactive experience, but rather a passive experience, and users complain of the sound effects being distracting when silent reading. Further, such systems are limited to providing audio sound effects.

### SUMMARY

Aspects and advantages of embodiments of the present disclosure will be set forth in part in the following description, or can be learned from the description, or can be learned through practice of the embodiments.

Embodiments of the present disclosure relate to special effects for a text source, such as a traditional paper book, e-book, website, mobile phone text, comic book, or any other form of pre-defined text, and an associated method and system for playing the special effects. In particular, the special effects may be played in response to a user reading the text source to enhance the enjoyment of their reading experience. The special effects can be customized to the particular text source and can be synchronized to initiate the special effect in response to the text source being read.

In embodiments of the disclosure, the text source can include a script, such as scripts associated with an advertisement, a performance (e.g., a play), a presentation, a speech, or other scripted works. In some embodiments, the text source can be a non-linear text source, such as scripts or other text content associated with a card game, a board game, or other interactive works that do not have a linear structure. For these embodiments, the special effects can be customized to the particular text or a set of combined text sources that in combination include text written on the cards, game pieces, game box, and/or instructions.

One example aspect of the present disclosure is directed to a computing system. The computing system can include one or more processors. The computing system can include a speech recognition system implemented by the one or more processors. The computing system can include one or more non-transitory computer-readable media that store instructions that when executed by the one or more processors cause the computing system to perform operations. The operations can include determining a current position of a speaker within a text source that can include a plurality of phrases. The operations can include identifying a set of expected phrases expected to be uttered by the speaker based at least in part on the current position of the speaker within the text source. The set of expected phrases can be a subset of the plurality of phrases included in the text source. The operations can include obtaining audio data descriptive of a human speech utterance. The operations can include recognizing, by the speech recognition system, the human speech utterance based at least in part on the audio data. An output of the speech recognition system can be biased toward the set of expected phrases. The operations can include determining whether to cause occurrence of a special effect based at least in part on the output of the speech recognition system.

In some embodiments, recognizing, by the speech recognition system, the human speech utterance can include generating, by the speech recognition system, an initial output that includes a plurality of hypothesized phrases; and selecting one of the plurality of hypothesized phrases based at least in part on the set of expected phrases.

In some embodiments, selecting one of the plurality of hypothesized phrases based at least in part on the set of expected phrases can include selecting a first hypothesized phrase that is included in the set of expected phrases.

In some embodiments, the initial output from the speech recognition system can further include a plurality of confidence scores respectively associated with the plurality of hypothesized phrases. In some embodiments, selecting one of the plurality of hypothesized phrases based at least in part on the set of expected phrases can include: identifying a subset of the hypothesized phrases that are included in the set of expected phrases; and selecting the hypothesized phrase that has the largest confidence score in the subset of the hypothesized phrases.

In some embodiments, recognizing, by the speech recognition system, the human speech utterance can include: generating, by the speech recognition system, an initial output that includes a plurality of hypothesized phrases and a plurality of confidence scores respectively associated with the plurality of hypothesized phrases; increasing the confidence score of any hypothesized phrase that is included in the set of expected phrases; and after increasing the confidence score of any hypothesized phrase that is included in the set of expected phrases, selecting the hypothesized phrase that has the largest confidence score.

In some embodiments, the speech recognition system can include a machine-learned speech recognition model that has been trained to preferentially recognize speech utterances in audio data that match a set of input text provided to the machine-learned speech recognition model at an inference time at which the machine-learned speech recognition model recognizes the speech utterances. In some embodiments, recognizing, by the speech recognition system, the human speech utterance can include: inputting the audio data into a machine-learned speech recognition model; and providing the set of expected phrases as an additional input to the machine-learned speech recognition model.

In some embodiments, the set of expected phrases consists of a next word expected to be uttered by the speaker. In some embodiments, the output of the speech recognition system can be biased toward the next word.

In some embodiments, the set of expected phrases consists of a set of phrases included on a same page as the current position of the speaker. In some embodiments, the output of the speech recognition system can be biased toward the set of phrases included on the same page as the current position of the speaker. For embodiments that include multiple speakers who each have a part or role in the text source, some embodiments can be biased using vocal recognition to determine the current speaker's position in the text source. In embodiments with multiple speakers, the speech recognition system can be biased toward the set of phrases for the current speaker and/or the next speaker.

In some embodiments, the computing system consists of an electronic mobile device.

Another example aspect of the present disclosure is directed to a computer-implemented method. The method can include determining, by one or more computing devices, a current position of a speaker within a text source that can include a plurality of phrases. The method can include identifying, by the one or more computing devices, a set of expected phrases expected to be uttered by the speaker based at least in part on the current position of the speaker within the text source. The set of expected phrases can be a subset of the plurality of phrases included in the text source. The method can include obtaining, by the one or more computing devices, audio data descriptive of a human speech utterance. The method can include performing, by the one or more computing devices, one or more speech recognition techniques to recognize the human speech utterance. Performing, by the one or more computing devices, the one or more speech recognition techniques to recognize the human speech utterance can include biasing, by the one or more computing devices, an output of the one or more speech recognition techniques toward the set of expected phrases. The method can include determining, by the one or more computing devices, whether to cause occurrence of a special effect based at least in part on the output of the one or more speech recognition techniques.

In some embodiments, biasing, by the one or more computing devices, the output of the one or more speech recognition techniques toward the set of expected phrases can include: receiving, by the one or more computing devices, an initial output from the one or more speech recognition techniques. The initial output can include a plurality of hypothesized phrases. In some embodiments, biasing, by the one or more computing devices, the output of the one or more speech recognition techniques toward the set of expected phrases can further include selecting, by the one or more computing devices, one of the plurality of hypothesized phrases based at least in part on the set of expected phrases.

In some embodiments, selecting, by the one or more computing devices, one of the plurality of hypothesized phrases based at least in part on the set of expected phrases can include selecting, by the one or more computing devices, a first hypothesized phrase that is included in the set of expected phrases.

In some embodiments, the initial output from the one or more speech recognition techniques further can include a plurality of confidence scores respectively associated with the plurality of hypothesized phrases. In some embodiments, selecting, by the one or more computing devices, one of the plurality of hypothesized phrases based at least in part on the set of expected phrases can include: identifying, by the one or more computing devices, a subset of the hypothesized phrases that are included in the set of expected phrases; and selecting, by the one or more computing devices, the hypothesized phrase that has the largest confidence score in the subset of the hypothesized phrases.

In some embodiments, biasing, by the one or more computing devices, the output of the one or more speech recognition techniques toward the set of expected phrases can include: receiving, by the one or more computing devices, an initial output from the one or more speech recognition techniques. The initial output can include a plurality of hypothesized phrases and a plurality of confidence scores respectively associated with the plurality of hypothesized phrases. In some embodiments, biasing, by the one or more computing devices, the output of the one or more speech recognition techniques toward the set of expected phrases can further include: increasing, by the one or more computing devices, the confidence score of any hypothesized phrase that is included in the set of expected phrases; and after increasing, by the one or more computing devices, the confidence score of any hypothesized phrase that is included in the set of expected phrases, selecting, by the one or more computing devices, the hypothesized phrase that has the largest confidence score.

In some embodiments, performing, by the one or more computing devices, the one or more speech recognition techniques to recognize the human speech utterance can include inputting, by the one or more computing devices, the audio data into a machine-learned speech recognition model. In some embodiments, biasing, by the one or more computing devices, the output of the one or more speech recognition techniques toward the set of expected phrases can include providing, by the one or more computing devices, the set of expected phrases as an additional input to the machine-learned speech recognition model.

In some embodiments, the machine-learned speech recognition model has been trained to preferentially recognize speech utterances in audio data that match a set of input text provided to the machine-learned speech recognition model at an inference time at which the machine-learned speech recognition model recognizes the speech utterances.

In some embodiments, identifying, by the one or more computing devices, the set of expected phrases expected to be uttered by the speaker based at least in part on the current position of the speaker within the text source can include identifying, by the one or more computing devices, a next word expected to be uttered by the speaker based at least in part on the current position of the speaker. In some embodiments, biasing, by the one or more computing devices, the output of the one or more speech recognition techniques toward the set of expected phrases can include biasing, by the one or more computing devices, the output of the one or more speech recognition techniques toward the next word.

In some embodiments, identifying, by the one or more computing devices, the set of expected phrases expected to be uttered by the speaker based at least in part on the current position of the speaker within the text source can include identifying, by the one or more computing devices, a set of phrases included on a same page as the current position of the speaker. In some embodiments, biasing, by the one or more computing devices, the output of the one or more speech recognition techniques toward the set of expected phrases can include biasing, by the one or more computing devices, the output of the one or more speech recognition techniques toward the set of phrases included on the same page as the current position of the speaker.

In some embodiments the method can further include, activating, by the one or more computing devices, acoustic echo prevention within attenuating an associated audio output.

Another example aspect of the present disclosure is directed to one or more non-transitory computer-readable media that store instructions that when executed by one or more processors cause the one or more processor to perform operations. The operations can include determining a current position of a speaker within a text source that can include a plurality of phrases. The operations can include identifying a set of expected phrases expected to be uttered by the speaker based at least in part on the current position of the speaker within the text source. The set of expected phrases can be a subset of the plurality of phrases included in the text source. The operations can include obtaining audio data descriptive of a human speech utterance. The operations can include performing one or more speech recognition techniques to recognize the human speech utterance. Performing, by the one or more computing devices, the one or more speech recognition techniques to recognize the human speech utterance can include biasing, by the one or more computing devices, an output of the one or more speech recognition techniques toward the set of expected phrases. The operations can include determining whether to cause occurrence of a special effect based at least in part on the output of the one or more speech recognition techniques.

Another example aspect of the present disclosure is directed to a computing system. The computing system can include one or more processors and one or more non-transitory computer-readable media that store instructions that when executed by the one or more processors cause the computing system to perform operations. The operations can include obtaining audio data descriptive of a human speech utterance uttered by a speaker. The operations can include performing a position-based tracking technique that tracks a current position of the speaker within a text source. The operations can include performing a keyword spotting technique in parallel with the position-based tracking technique. The operations can include determining whether to cause occurrence of a special effect based at least in part on a first output of the position-based tracking technique or a second output of the keyword spotting technique.

In some embodiments, performing the position-based tracking technique that tracks the current position of the speaker within the text source can include obtaining a script for the text source. The script can provide a plurality of phrases included in the text source and a plurality of positions respectively associated with the plurality of phrases. In some embodiments, performing the position-based tracking technique that tracks the current position of the speaker within the text source can further include recognizing a first phrase within the audio data descriptive of the human speech utterance and updating the current position of the speaker to a first position associated with the recognized first phrase in the script.

In some embodiments, performing the keyword spotting technique can include: recognizing a first phrase within the audio data descriptive of the human speech utterance; and comparing the first phrase to a set of keywords to determine if the first phrase matches any of the set of keywords. In some embodiments, the set of keywords can be associated with and specific to a range of positions that includes the current position of the speaker.

In some embodiments, the computing system is configured to perform said keyword spotting technique in parallel with the position-based tracking technique only when the current position of the speaker is within a predefined range of positions.

In some embodiments, the computing system is configured to cease performing said keyword spotting technique when the current position of the speaker is outside of a predefined range of positions.

In some embodiments, determining whether to cause occurrence of the special effect based at least in part on the first output of the position-based tracking technique or the second output of the keyword spotting technique can include causing occurrence of the special effect if either of the first output or the second output indicate that the special effect should occur.

In some embodiments, determining whether to cause occurrence of the special effect based at least in part on the first output of the position-based tracking technique or the second output of the keyword spotting technique can include causing occurrence of the special effect if both of the first output or the second output indicate that the special effect should occur.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

The foregoing summary, as well as the following detailed description of preferred embodiments of the invention, will be better understood when read in conjunction with the appended drawings. It should be understood that the invention is not limited to the precise arrangements and instrumentalities shown.

Detailed discussion of embodiments directed to one of ordinary skill in the art is set forth in the specification, which makes reference to the appended figures, in which:

FIG. 1 is a general overview of an example system according to an example embodiment of the present disclosure;

FIG. 2 is a schematic representation of example operation of a soundtrack according to an example embodiment of the present disclosure;

FIG. 3 is a specific example of an example soundtrack associated with a text source according to an example embodiment of the present disclosure;

FIG. 4 is a block diagram illustrating an example arrangement of soundtrack files associating with one or more text sources according to an example embodiment of the present disclosure;

FIG. 5 is a block diagram illustrating example components of an example electronic device, and their interaction with other components of an example system according to an example embodiment of the present disclosure;

FIG. 6 is an example flow chart depicting an example method of operation of playing sound effects associating with a text source according to embodiments of the present disclosure;

FIG. 7 is a diagram illustrating various connected devices according to example embodiments of the present disclosure;

FIG. 8 is an example flow chart depicting an example method of providing special effects for a text source according to example embodiments of the present disclosure;

FIG. 9 is an example flow chart depicting an example method of tracking a position of a speaker within a script;

FIG. 10 is an example flow chart depicting an example method of providing special effects for a text source according to example embodiments of the present disclosure;

FIG. 11 is an example flow chart depicting an example method of providing special effects for a text source according to example embodiments of the present disclosure;

FIG. 12 is an example flow chart depicting an example method of providing special effects for a text source according to example embodiments of the present disclosure;

FIG. 13 is an example flow chart depicting an example method of training a machine-learned speech recognition model for improved performance against special effects according to example embodiments of the present disclosure;

FIG. 14 is an example flow chart depicting an example method of providing special effects for a text source according to example embodiments of the present disclosure; and

FIG. 15 is an example script for a text source according to example embodiments of the present disclosure.

### DETAILED DESCRIPTION

Example aspects of the present disclosure are directed to systems, methods, and computer program products that relate to special effects for a text source, such as a traditional paper book, e-book, mobile phone text, comic book, or any other form of pre-defined reading material, and for outputting the special effects. The special effects may be played in response to a user reading the text source aloud to enhance their enjoyment of the reading experience and provide interactivity. The special effects can be customized to the particular text source and can be synchronized to initiate the special effect in response to pre-programmed trigger phrases when reading the text source aloud.

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

A reader's experience may be enhanced if, while reading a text source, special effects, such as, for example, audio sounds, music, lighting, fans, vibrations, air changes, temperature changes, other environmental effects and the like, are triggered in synchronization when specific words or phrases of the text source are read.

For example, a system may be configured to detect, via a speech recognition module, a particular pre-determined word or phrase of a text source, process, and output a special effect related to one or more portions (e.g., feature words) of the text source.

As another example, a system may be configured to detect or estimate the reader's position in a book through an estimation of a reading speed or through eye tracking.

Certain embodiments of the present disclosure can synchronize special effects and compensate for a time delay by including a system programmed to begin processing and outputting a special effect related to the feature word prior to the feature word being read by the reader. As a result, there may appear to be no delay between the time the feature word is read by reader, and the initiation of the special effect related to the feature word. Stated differently, the special effect related to the feature word may be initiated generally simultaneously to the reader reading the feature word, providing an enjoyable “real-time” enhanced reading experience.

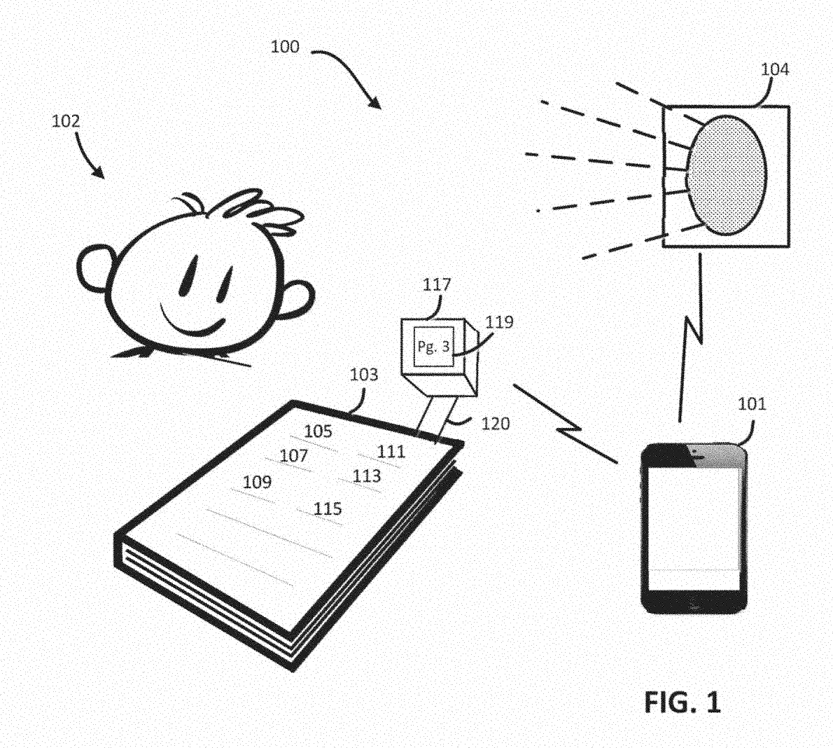

Referring now to FIG. 1, a system 100 for generation of a special effect according to an embodiment of the disclosure is shown. In the system 100, an electronic device 101 may be used (such as by a reader 102) in conjunction with a text source 103, and one or more special effect modules 104.

In particular, in some embodiments, the electronic device 101 can be configured to recognize when the speaker utters one or more phrases from the text source 103 and, in response to recognition of the one or more phrases, cause one or more special effects to occur. As one example, in some embodiments, the electronic device 101 can perform a keyword spotting technique that recognizes particular phrases and causes special effects based on the recognized phrases. As another example, in some embodiments, the electronic device 101 can perform a position-based bookmarking technique that tracks a speaker's position within the text source. For example, the speaker's position can be updated on a per-phrase basis.

As yet another example, in some embodiments, the electronic device 101 can perform the keyword spotting technique and the position-based bookmarking technique in parallel and/or can switch between the keyword spotting technique and the position-based bookmarking technique as desired. For example, in one particular example embodiment, when the current position of the speaker is within certain predefined ranges, the electronic device 101 can perform the keyword spotting technique and the position-based bookmarking technique in parallel. However, in such example embodiment, when the current position of the speaker is outside the predefined ranges, the electronic device 101 can perform the position-based bookmarking technique only.

Referring again to FIG. 1, the text source 103 may refer to any pre-defined text, such as, for example, a book such as a children's book, a board book, a chapter book, a novel, a magazine, a comic book, and the like; a script such as a manuscript, a script for a play, movie, and the like; a text message; electronic text, such as text displayed on, for example, a computer, a mobile device, a television, or any other electronic display device.

In particular embodiments, the text source 103 can be a traditional printed text, also referred to herein as a physical text source. In other particular embodiments, the text source 103 can be electronically displayed text, also referred to herein as an electronic text source.

In some embodiments, the text source 103 can be a linear text source that progresses (e.g., a story or narrative) in a linear fashion. In other embodiments, the text source 103 can be a non-linear text source. For example, non-linear text sources can include branched text sources, forked text sources, multi-forked text sources, text sources with jumps or bridges between portions, or other text sources that are designed to be read or otherwise consumed in a non-linear fashion.

In certain embodiments, the text source 103 can be a pre-existing text source. For example, in certain embodiments, the special effects can be correlated to the text source long after creation of the text source. In this way, special effects can be correlated to any pre-existing text sources including, but not limited to, text printed days, weeks, months, years, or even centuries ago. Thus, no redistribution of the text source with the system 100 is required to provide correlated special effects to the text source.

The text source 103 may include one or more words, or strings of characters, some of which can be trigger phrases, such as trigger phrases 105, 107, 109, and so on. A trigger phrase 105, 107, 109 may refer to one or more words, or string(s) of characters, programmed to elicit one or more responses from one or more components of the electronic device 101. The text source 103 may also include one or more feature phrases 111, 113, 115 which may refer to one or more words or phrases to which a special effect may be related.

Thus, a text source 103 can include a plurality of phrases. As used herein, the term “phrase” refers to n items from the text source 103, where n is representative of a number. The items can be characters, phonemes, syllables, or words. In some instances, the items can be in arranged in or according to a contiguous sequence. Each phrase can include any number of items (e.g., 1, 2, 3, 4, 5, etc.). As one example, the phrase “John jumped high” contains three words and can be referred to as a trigram. As another example, the phrase “Oklahoma” contains a single word and can be referred to as a unigram. As yet another example, the phrase “Oklahoma” contains four contiguous syllables and can be referred to as a quadrisyllabic. Use of syllables as the primary building block of phrases can enable more granular detection of phrases.

In some example embodiments, some (e.g., most) or all phrases included in a text source 103 can be bigrams. Thus, in such example embodiments, a text source 103 can be divided into a series of phrases, where each phrase includes two words (e.g., a bigram).

A trigger phrase 105, 107, 109 can include one or more phrases, but typically refers to a single phrase (which can include any number of contiguous items such as phonemes, syllables, or words (e.g., two words)). Likewise, a feature phrase 111, 113, 115 can include one or more phrases, but typically refers to a single phrase (which can include any number of contiguous items such as phonemes, syllables, or words (e.g., two words)). Further, the text source 103 can include phrases that are neither trigger phrases nor feature phrases.

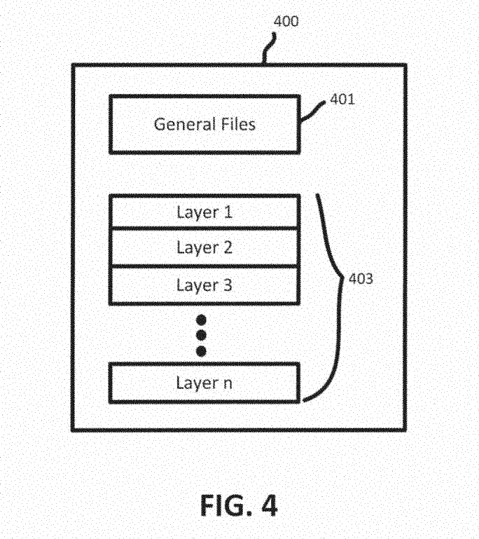

In some embodiments, the phrases of a text source 103 can be mapped to or otherwise represented by a script (not to be confused with discussion elsewhere herein of a script for a movie, play, etc. as an example text source). In particular, the script for a text source 103 can include the phrases of the text source 103. For example, the script for a text source 103 can include all of the phrases of the text source 103, including phrases that are trigger phrases and/or feature phrases and also phrases that are neither trigger phrases nor feature phrases. In some embodiments, the script can include the phrases of the text source 103 in an order according to which they are expected to be spoken or otherwise uttered. In some embodiments, the script can identify which phrases are trigger phrases and/or feature phrases and can provide, for such trigger phrases and/or feature phrases, identification of a corresponding special effect (e.g., a link to the corresponding layer file, as will be discussed with further reference to FIG. 4).

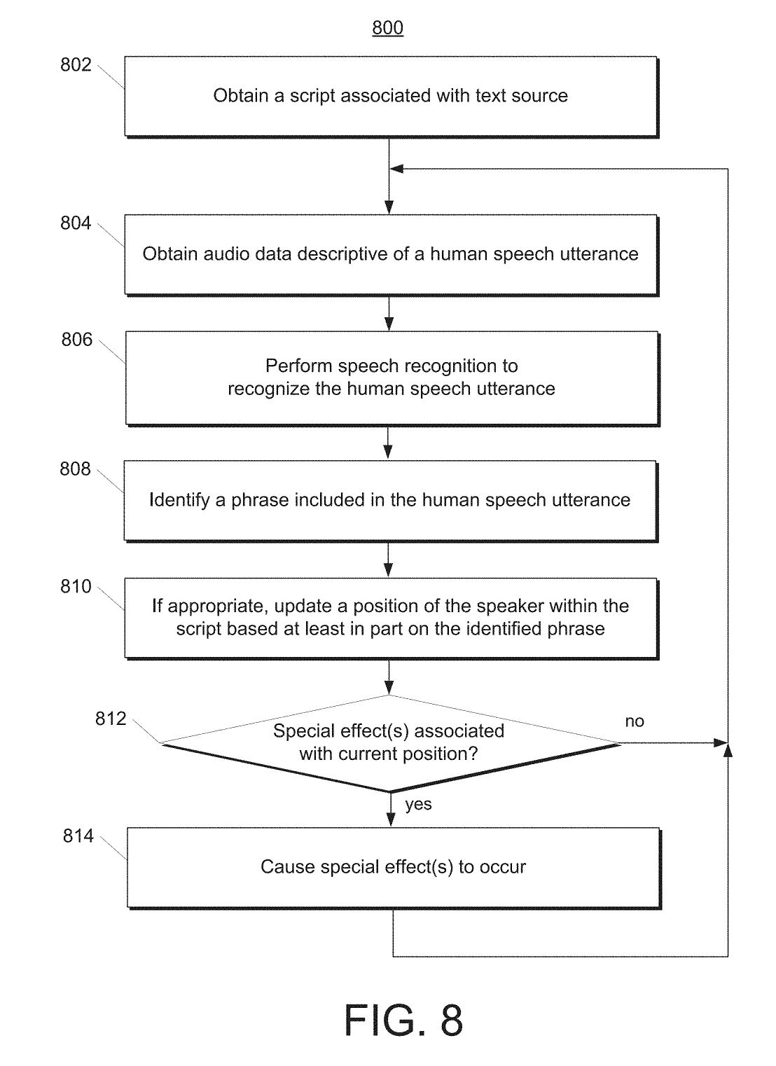

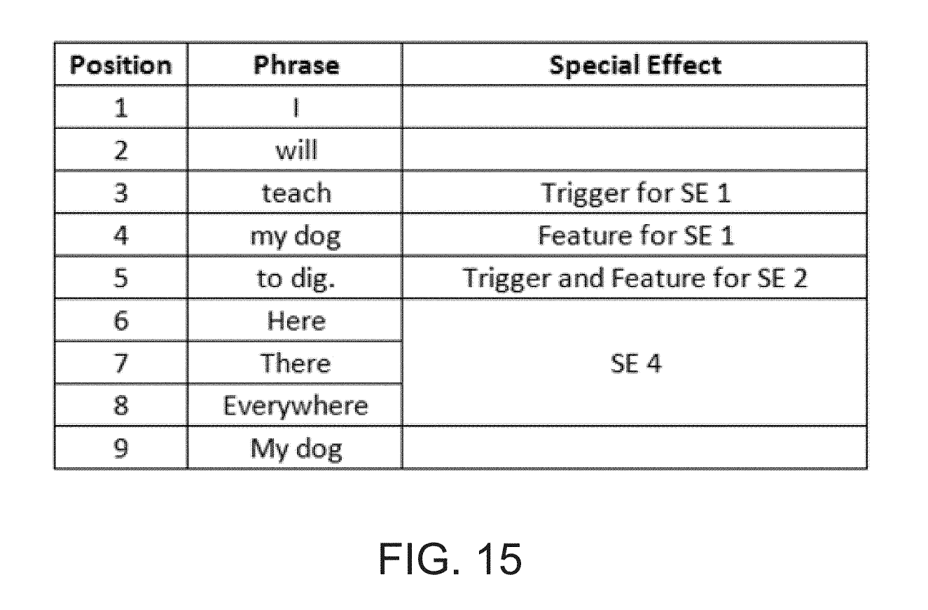

As one example, FIG. 15 provides a simplified example of a script for a text source 103. As shown in FIG. 15, the script can include a number of positions (e.g., positions 1-8). Each position can have a phrase associated therewith. Thus, in some implementations, a linearly increasing position value can be assigned to each phrase in a text source. As one example, a linearly increasing position value can be assigned to each phrase according to an order in which the phrases appear in the text source. Each phrase can include a number of items (e.g., contiguous items) such as characters, phonemes, syllables, or words. As one example, the phrase associated with position 3 (“teach”) includes one word while the phrase associated with position 4 (“my dog”) includes two contiguous words. In other embodiments, however, each position is associated with only a single item, such that each item has its own respective position. The electronic device 101 can perform a position-based bookmarking technique that tracks the speaker's position within the text source. For example, the speaker's position can be updated on a per-phrase basis. For example, when a phrase is recognized, the current position of the speaker can be updated to the corresponding position. Example techniques for performing position-based tracking are discussed with reference to FIGS. 8-11 and 15.

Referring again to FIG. 15, a special effect can be associated with one or more positions. As one example, position 3 and its corresponding phrase (“teach”) are labeled as a trigger phrase for special effect 1. As another example, position 4 and its corresponding phrase (“my dog”) are labeled as a feature phrase for the special effect 1. As yet another example, position 5 and its corresponding phrase (“to dig”) are labeled as both a trigger phrase and a feature phrase for special effect 2.

As another example, a special effect can be associated with a range of positions. For example, each of positions 6-8 and the corresponding phrases are labeled as being associated with a special effect 4. For example, any of these positions and/or phrases can serve as a trigger and/or feature phrase for the special effect 4. Thus, in some example instances, if any of phrases 6, 7, or 8 are recognized, then the special effect 4 can be triggered. This may be beneficial, for example, in scenarios where the text source is non-linear or otherwise not organized in a traditional left-to-right, top-to-bottom fashion. As one example, this scenario may occur in a children's book in which words or objects are randomly positioned around a page.

However, in other example instances, a special effect may require that all of the phrases associated with the special effect be recognized before the special effect is triggered. Thus, in some example instances, the special effect 4 can be triggered only when all of phrases 6, 7, or 8 are recognized. In some instances, the phrases 6, 7, and 8 must be recognized according to their order (e.g., 6 then 7 then 8) for the special effect 4 to be triggered while, in other instances, the special effect 4 is triggered so long as the phrases 6-8 are recognized contiguously in some order (e.g., 8 then 6 then 7), whether serially increasing in number or not.

In some embodiments, the electronic device 101 can perform a keyword spotting technique and a position-based bookmarking technique in parallel and/or can switch between the keyword spotting technique and the position-based bookmarking technique as desired. For example, in one particular example embodiment, when the current position of the speaker is within certain predefined ranges, the electronic device 101 can perform the keyword spotting technique and the position-based bookmarking technique in parallel. However, in such example embodiment, when the current position of the speaker is outside the predefined ranges, the electronic device 101 can perform the position-based bookmarking technique only.

In some embodiments, a single position and phrase can be associated with multiple different special effects (e.g., both an audio effect and an environmental effect). In some embodiments, a position (e.g., position 2) is not associated with any special effects. In some embodiments, special effects that are associated with ranges can overlap with or encompass the range(s) associated with other special effect(s). Ranges can include any number of positions.

Thus, in some embodiments, a script for a text source 103 may include an entire set of phrases from the text source 103. This may be in contrast to a list, file, or database that includes only phrases from the text source 103 that are trigger phrases and/or feature phrases. Use of a script as described above may be useful for tracking a position of a speaker within a text source, by enabling per-phrase tracking even when the currently spoken phrase is not a trigger phrase and/or feature phrase. However, embodiments of the present disclosure are not required to use a script to provide special effects and may provide special effects by other means such as, for example, a list, file, or database that includes only phrases from the text source 103 that are trigger phrases and/or feature phrases.

Referring again to FIG. 1, as discussed above, it may be desirable to have a particular special effect played generally simultaneous to the feature phrase being read and/or spoken. The system 100 may be programmed to command one or more of the special effect output modules 104 to play the special effect upon detection of one or more trigger phrases 105, 107, 109. Therefore, by the time the processing of the command is complete and an actual special effect is output, the reader may be simultaneously reading the feature phrase 111, 113, 115 to which the special effect is related. As such, the system 100 may be programmed to synchronize playback of a desired special effect generally simultaneously with the feature phrase 111, 113, 115 being read by initiating playback of the special effect when one or more trigger phrases 105, 107, 109 are detected. In this context, it is to be understood that “generally simultaneously” refers to immediately before, during, and/or immediately after the feature phrase is being read.

In certain embodiments, at least one of the words in a feature phrase 111, 113, 115 can be the same as at least one of the words in a trigger phrase 105, 107, 109. In other embodiments, no words can overlap between a feature phrase 111, 113, 115 and a trigger phrase 105, 107, 109. Thus, in some instances, a trigger phrase may be (at least partially) separate from but associated with a corresponding feature phrase, while in other instances the same phrase can be both a trigger phrase and the corresponding feature phrase.

In further embodiments, the trigger phrase 105, 107, 109 can be designed to be read before the feature phrase 111, 113, 115.

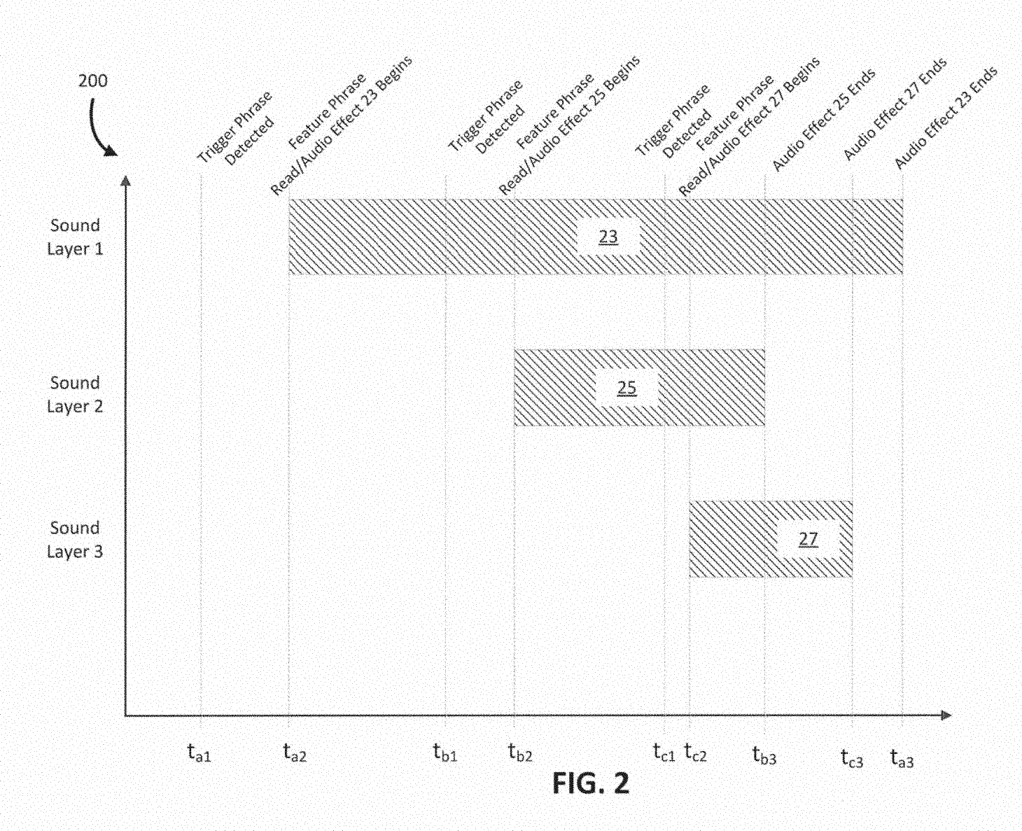

With reference to FIG. 2, a schematic representation of a portion of a special effect track 200 for a text source 103 is shown. The special effect track 200 may be multi-layered comprising one or more special effects that may play separate or concurrently during reading of the text source 103. Each special effect layer may include one or more special effects. By way of example, three special effect layers are shown, although it will be appreciated that any number of layers could be provided in other forms of the text source profile. Each of the special effect layers 1, 2, and 3 may represent any type of special effect, including but not limited to an auditory effect, a visual effect, an environmental effect, other special effects, and combinations thereof.

The system 100 of FIG. 1 may optionally include a second electronic device 117 which may include a microphone or other type of audio detector capable of detecting audio. The second electronic device 117 may communicate the detected audio to the electronic device 101, via any communication method described herein throughout, which may include, but is not limited to: Bluetooth, WI-FI, ZIGBEE, and the like. The second electronic device 117 may also take the form of a bookmark. As such, the electronic device 117 may include a page marking mechanism 119 that is adapted to identify to a user the current page on the book if reading has stopped part way through the book. The second electronic device may include an engagement mechanism 120 that is adapted to secure the second electronic device 117 to the text source 103. As shown, the second electronic device 117 is attached to the text source 103. It should be noted, however, that the second electronic device 117 may be attached to other elements, such as, for example, the reader 102, or any object.

In certain embodiments, auditory effects can include atmospheric noise, background music, theme music, human voices, animal sounds, sound effects and the like. For example, atmospheric noise may refer to weather sounds, scene noise, and like. Background music may refer to orchestral music, songs, or any other musical sounds. Other audible effects may refer to animal sounds, human voices, doors shutting, and the like, that are programmed to play upon detection of a trigger phrase.

In certain embodiments, visual effects can include any special effect that is designed to be viewable by an active and/or passive user. For example, visual effects can include visual information on an electronic display such as a computer, a mobile device, a television, a laser, a holographic display, and the like. Further, visual effects can include animation, video, or other forms of motion. Still further, visual effects can include other light sources such as a lamp, a flashlight, such as a flashlight on a mobile device, car lights, Christmas lights, laser lights, and the like.

As used herein, the phrase “environmental special effect” refers to a special effect which affects the user's sense of touch, sense of smell, or combinations thereof. For example, an environmental special effect can include fog generated by a fog machine; wind generated by a fan; vibrations generated by a massaging chair; physical movements of a user generated by a movable device, for example a wheel chair; and the like.

As used herein, an environmental special effect does not refer solely to auditory special effects such as sound effect, music and the like. Further, as used herein, an environmental special effect does not refer solely to a visual special effect. Moreover, as used herein, an environmental special effect does not refer solely to a combination of an auditory special effect and a visual special effect.

As shown in the example soundtrack depicted in FIG. 2, upon trigger time ta1, special effect 23 of special effect layer 1 may be programmed to begin playback at time ta2 (e.g., an approximate time the reader may read a feature phrase) and to end playback at time ta3. At time tb1, special effect 25 of special effect layer 2 may be programmed to begin playback at time tb2 and to end playback at time tb3. Similarly, upon trigger time tc1, special effect 27 of layer 3 may be programmed to begin playback at time tc2 and end playback at time tc3.

Trigger times ta1, tb1, tc1 correspond to triggers for respective special effect layers 1, 2, and 3. A trigger time ta1, tb1, or tc1 may correspond to a time when the system detects a trigger phrase. Each special effect may be configured to play for any desired length of time, which may be based on one or more various factors. For example, with respect to a special effect of one of the special effect layers (e.g., special effect 23 of layer 1), playback end time ta3 may correspond to detection of another trigger phrase of layer 1, playback of another special effect of layer 1 or detection of another trigger phrase or playback of another special effect of different layer (e.g., layer 2 and/or layer 3). Alternatively, or additionally, a special effect may be programmed to play for a predetermined duration of time. For example, each special effect may be configured to play for 3 seconds. As such, for special effect layer 1, ta3 may refer to a time 3 seconds after ta2. As another alternative, each special effect may be configured to play for a random duration of time (e.g. through the use of a random number generator to randomly generate a time duration for one or more of the audio effects, as a part of the system 100).

Thus, in some instances, special effects may be programmed or otherwise configured to occur (e.g., be played) for a predetermined or random period of time (e.g., 3 seconds) and then to cease after such predetermined or random period of time expires. In other instances, special effects may be programmed or otherwise configured to occur (e.g., be played) until a certain ending phrase is recognized. In yet other instances, special effects may be programmed or otherwise configured to occur (e.g., be played) until a phrase is recognized that is not associated with such special effect (e.g., until the current position of the speaker is outside of a range associated with such special effect.

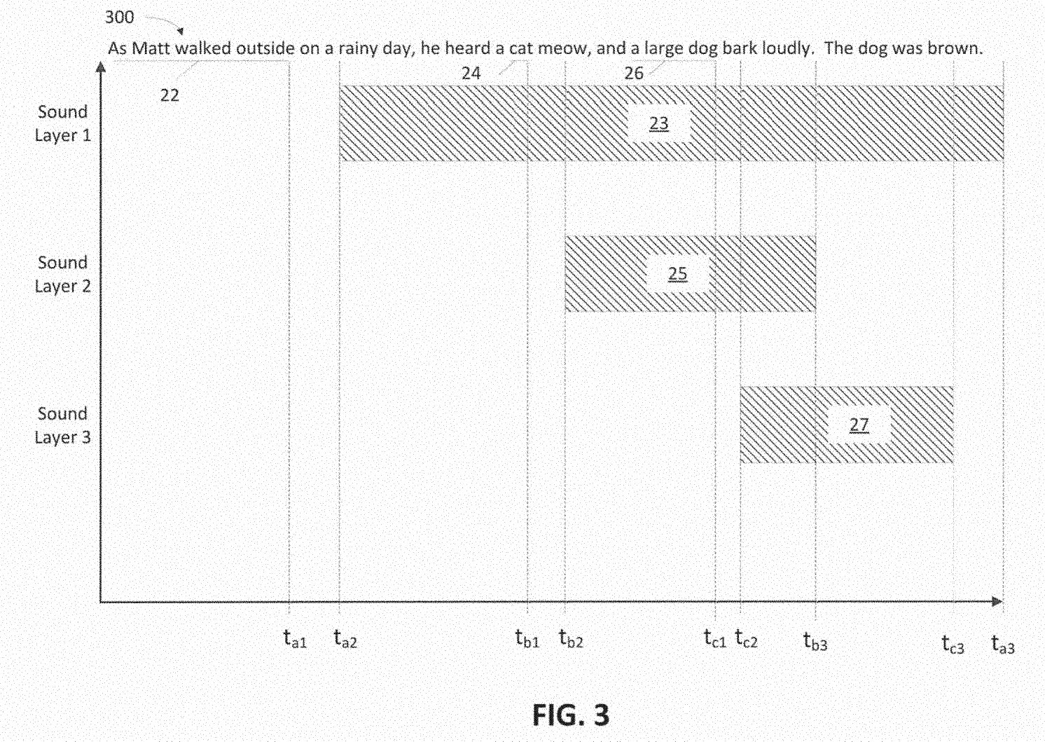

FIG. 3 is a specific example operation of a special effect track for a text source 300. For the sake of simplicity, the text source 300 consists of only two sentences. It should be appreciated, however, that the text source 300 may be of any length. It should also be noted that the trigger phrases may be of any desired length. The trigger phrase 22 may be denoted as the sequence of words “[a]s matt walked outside”. The system 100 may detect this trigger phrase at time ta1, and, at time ta2 (corresponding to an approximate time when the reader may speak the feature phrase “rainy”), with respect to special effect layer 1, play special effect 23 comprising weather sounds such as rain drops hitting the ground. Therefore, any processing necessary to output a special effect of rainy weather may be performed prior to the reader actually reading the feature phrase “rainy”. As a result, the system 100 is able to play the rainy weather sounds generally simultaneously to the reader reading the feature phrase rainy, providing an enjoyable “real-time” enhanced reading experience.

Another trigger phrase 24 may be the word “cat.” The system 100 may detect this trigger phrase at time tb1, and, at time tb2, corresponding to an approximate time the reader may be reading the feature phrase “cat,” play the special effect 25 comprising a loop of a sound of a cat's meow. Therefore, any system processing necessary to output sounds of cat meowing may be performed prior to the reader actually reading the feature phrase “meow.” As a result, the system 100 is able to play the special effect 25 of a cat's meow generally simultaneously to the reader reading the feature word “meow.”

With respect to special effect layer 3, another trigger phrase 26 of the text source 30 may be the sequence of words “and a large dog.” The system 100 may detect this trigger phrase at time tc1, and begin playback of the special effect 27 at time tc2. Therefore, any processing necessary to output sounds of a dog barking may be performed prior to the reader actually reading the feature phrase “bark”. As a result, the system 100 is able to play the special effect 27 of a dog barking generally simultaneously to the reader reading the feature word “bark”, providing an enjoyable “real-time” enhanced reading experience.

At least because of the multi-layer nature of the special effect track, according to this example, for a period of time, a reader is able to experience the special effects of rain hitting the ground, a cat meowing, and a dog barking concurrently.

Continuing with this example, the special effect 23 (e.g., the sound of rain hitting the ground) may be programmed to end playback at time ta3. Similarly, the sound of the cat's meowing may be programmed to end at tb3, and the dog's barking may be programmed to end at tc3. It should be noted that one or more layers of the special effect track may also be “pre-mixed.” For example, in response to detection of a single trigger phrase, one or more special effects of special effect layer 1 may be pre-programmed to play for a pre-determined period of time, one or more special effects of special effect layer 2 may be pre-programmed to begin playback after a pre-determined time of the playback of one or more effects of special effect layer 1, and one or more audible effects of special effect layer 3 may be pre-programmed to begin playback after a pre-determined time after the playback of one or more special effects of layers 1 and/or 2. The pre-mixed special effect track may be based on an average reading speed, which may be updated (e.g., sped up or slowed down), at any given time by an operator of the system. Further, the system 100 may be able to detect and modify the pre-mixed special effect tracks based on user's reading speed ascertained by the system 100.

It should be appreciated that the special effect track may be packaged into various file formats and arrangements for interpretation and playing by corresponding special effect software running on a special effect player. By way of example only, referring now to FIG. 4, the special effect track may comprise a package of special effect files 400. The special effect files 400 may include a general data file 401 and one or more layer files 403 corresponding to each of the special effect layers of a special effect track for one or more text sources 103. It will be appreciated that that the special effect track may alternatively comprise only the data files 401, 403 and that the layer files may be retrieved from a database or memory during playing of one or more special effects of one or more layers of the text source special effect profile, and, in such forms, one or more of the data files 401, 403 may contain linking or file path information for retrieving the special effect files from memory, a database, or over a network.

The general data file 401 may comprise general profile data such as, but not limited to, the name of the special effect track, the name of the text source with which the profile is associated, and any other identification or necessary special effect information or profile information. The general data file 401 may also comprise reading speed data, which may include average reading speed data duration of the overall text source profile. Additionally, the general data file 401 may include layer data comprising information about the number of special effect layers in the text source profile and names of the respective special effect layers. The layer data may also include filenames, file paths, or links to the corresponding layer data file 403 of each of the special effect layers. In some embodiments, the general data file 401 for the one or more text sources 103 can include one or more scripts respectively for the one or more text sources 103. In some embodiments, the script for each text source 103 can identify certain phrases included in the text source 103 that are trigger phrases and/or feature phrases that are linked to certain special effects (e.g., as provided by layer files 403).

Each layer file 403 may include special effects, which may include one or more special effects for each layer, and the trigger phrase associated with each of the one or more special effects for each layer. The layer file 403 may also provide information on the particular special effect features associated with the one or more special effects of the respective special effect layer. For example, any predetermined durations of time of which one or more special effects is set to play, and optionally, other special effect feature properties, such as, for example, transition effects, such as fade-in, fade-out times, volume, looping, and the like.

It should be appreciated that the above description of the special effect files 400 is by way of non-limiting example only. As such, data and special effects needed for creation and operation of embodiments of the disclosure may be stored in any combination of files. For example, one or more layer files 403 may be included in the general file 401, and vice versa.

In certain embodiments, a library of trigger phrases can be arranged in a plurality of discrete databases. For example, a text source, such as a book, can include, 100 pages of text including 10 chapters. Each chapter can have a discrete database of pre-programmed trigger phrases. Further, at least one trigger phrase can, instead of or in addition to initiating a special effect, can initiate the system to access a different database of trigger phrases for subsequent text that is read, also referred to herein as a database transition trigger phrase. By way of non-limiting example only, while reading from chapter 1 (to which system 100 may include a corresponding database) of a book, the reader may read a trigger phrase, which may cause the system 100 to output a special effect, and, additionally prompt the system 100 to access another database corresponding to another chapter (e.g., chapter 2). Alternatively, upon reception of the trigger phrase, the system 100 may not output a special effect, but simply be prompted to switch to another database. It should be noted that databases may correspond to other portions of text sources in keeping with the invention. For example, a single chapter of a text source may include multiple databases. Also, databases may simply correspond to different portions of a text source that has no designated chapters.

In other embodiments, essentially all of the trigger phrases can be included in a single database. In some embodiments, the system 100 may include functionality to operate with different languages. For example, a first database may include pre-determined trigger phrases of one or more different languages, which, as used herein may refer to dialects, speech patterns, and the like. Therefore, in operation, one or more processors of the electronic device may be configured to access the first database. The system 100 may detect, for example, via a speech algorithm, the language of the detected pre-determined trigger phrase. Based on the detected pre-determined trigger phrase of the first database, the system may access a second database which may include a plurality of pre-determined trigger phrases which may be the same language as the detected pre-determined trigger phrase of the first database. And, in response to determined that at least one of the pre-determined trigger phrases of the second database is detected, the system 100 may command a special effect output device to play a special effect. It should be noted that the system 100 may include functionality to operate with any number of languages and databases.

In some embodiments, a text source having a plurality of trigger phrases may have different active trigger phrases at given times. For example, at one point in time or portion of reading of the text source, a first group of trigger phrases may be active (e.g., set to effect an action by the system upon being matched to the auditory input of the text source). At another point in time or portion of reading of the text source, a second group of trigger phrases may be active. The group of trigger phrases that are active may be referred to as a window, which may change as subsequent words, or trigger phrases of the text source are read.

For example, a text source may contain words 1-15, and, for the sake of simplicity, in this example, a trigger word or phrase corresponds to each word of the text source. At one point in time, active trigger words may correspond to words 1-5, respectively, while triggers corresponding to words 6-15 may currently be inactive. However, after word “1” is spoken, the window of active trigger word may “slide.” As such, triggers for words 2-6 may now become active, and word “1” now becomes inactive. After trigger word “2” is spoken, the window may again slide so that words 3-7 are active, while words “1” and “2” become inactive, and so on. It should be noted that the designation of active vs. inactive triggers need not be sequential. For example, triggers may become active or inactive randomly, or by user, or other means of designation.

In some embodiments, the system 100 may command the output of special effects related to a location remote from the general location of the text source. Such an output of the special effects may be based, at least in part, on sensory information. The sensory information may include auditory information, visual information, environmental information, or any combination thereof, of the remote location.

For example, one or more special effect tracks may comprise live feeds (e.g., live audio stream) associated with one or more text sources. For example, a text source may contain content about the sights and sounds of New York City. One or more portions of a special effect track associated with the text source may be configured to have one or more trigger phrases that elicit one or more special effects in the form of actual live content, such as audio, video, or environmental effects from sites or locations around New York City. Such sites may have microphones, cameras, sensors, such as temperature sensors, humidity sensors, wind speed sensors, etc. coupled to a network to allow for communication with other components of the system 100 to pick up the live feeds and play the same through the electronic device 101 and/or one or more special effect devices.

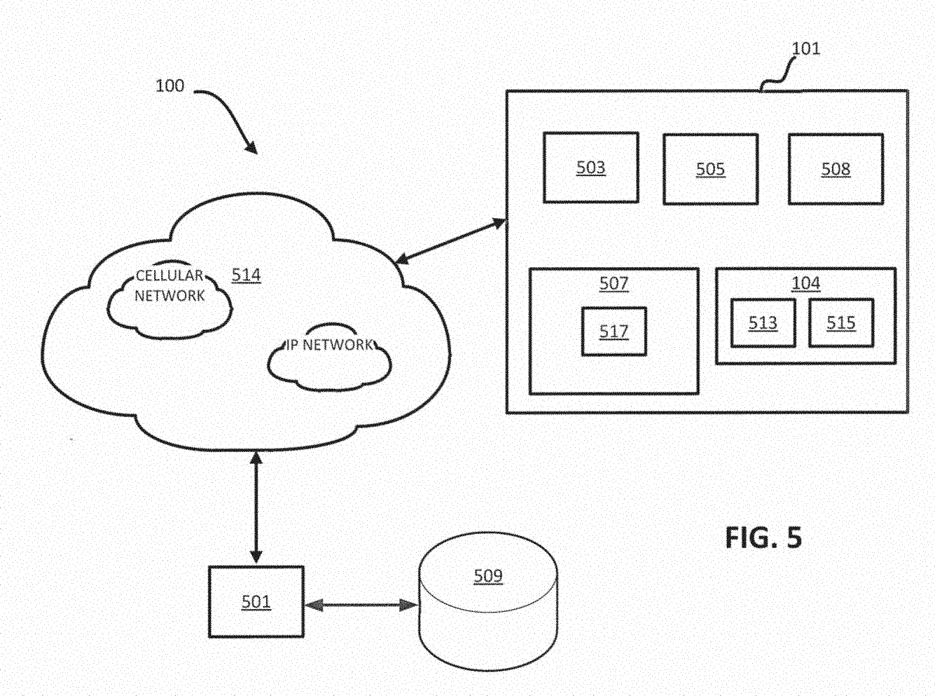

FIG. 5 is a perspective block diagram of some of the components of the system 100. The system 100 may include a server 501 and the electronic device 101 (as discussed above), which may include an input unit 503, a processor 505, a speech recognition module 507, a memory 508, a database 509, and one or more special effect output modules, such as audio output module 104 which is adapted to produce an auditory special effect. The database 509 may include one or more special effect track files associated with respective text sources (such as, for example, the afore-discussed special effect track files 400).

The audio output module 104 may include a speaker 513, a sound controller 515, and various related circuitry (not shown), which may work with the sound controller 515 to activate the speaker 513 and to play audio effects stored in the database 509 or locally in the memory 508 in a manner known to one of ordinary skill in the art. The processor 505 may be used by the audio output module 104 and/or related circuitry to play the audio effects stored in the memory 508 and/or the database 509. Alternatively, this functionality may be performed solely by the related circuitry and the sound controller 515.

The speech recognition module 507 may include a speech recognition controller 517, and other related circuitry (not shown). The input unit 503 may include a microphone or other sound receiving device (e.g., any device that converts sound into an electrical signal). The speech recognition controller 517 may include, for example, an integrated circuit having a processor (not shown). The input unit 503, speech recognition controller 517, and the other related circuitry, may be configured to work together to receive and detect audible messages from a user (e.g., reader) or other sound source (not shown). For example, the speech recognition module 507 may be configured to receive audible sounds from a reader or other source, such as an audio recording, and to analyze the received audible sounds to detect trigger phrases. Based upon the detected trigger phrase (or each detected sequence of trigger phrase(s)), an appropriate response (e.g., special effect) may be initiated. For example, for each detected trigger phrase, a corresponding special effect may be stored in the memory 508 or the database 509. The speech recognition module 507 may employ at least one speech recognition algorithm that relies, at least in part, on laws of speech or other available data (e.g., heuristics) to identify and detect trigger phrases, whether spoken by an adult, child, or electronically delivered audio, such as from a movie, a TV show, radio, telephone, and the like.

It should be noted that, in light of embodiments of the disclosure herein, one of ordinary skill in the art may appreciate that the speech recognition module 507 may be configured to receive incoming audible sounds or messages and compare the incoming audible sounds to expected phonemes stored in the speech recognition controller 517, memory 508, or the database 509. For example, the speech recognition module 507 may parse received speech into its constituent phonemes and compare (e.g., by performing waveform matching) these constituents against those constituent phonemes of one or more trigger phrases. When a sufficient number of phonemes match between the received audible sounds and the trigger phrase(s), a match is recorded.

In further embodiments, the speech recognition module 507 may be configured to receive incoming audible sounds or messages and derive a score relating to the confidence of detection of one or more pre-programmed trigger phrases. When there is a match (or high enough score), the speech recognition module 507, potentially by the speech recognition controller 517 or the other related circuitry activates the correlated special effect. When there is no match (or no scores that exceed a base threshold), then the speech recognition module 507 can, in some embodiments, simply ignore the corresponding audible sounds.

In some embodiments, the speech recognition module 507 can include and employ a speech recognition model that receives audio data descriptive of the incoming audible sounds and is capable of detecting discrete syllables, phonemes, and/or words.

As one example, the speech recognition module 507 can include an acoustic model. The acoustic model can represent a relationship between an audio signal and the phonemes or other linguistic units that make up speech. In some embodiments, the acoustic model can be learned from a set of audio recordings and their corresponding transcripts.

As such, in some embodiments, the speech recognition model can be a machine-learned model. As another example, the speech recognition model can be a Markov model, such as a Hidden Markov Model and/or Markov Chain. As another example, the speech recognition model can be a neural network (e.g., deep neural network). Example neural networks include feed-forward networks, recurrent neural networks, convolutional neural networks, and combinations thereof. In yet further embodiments, the speech recognition module 507 can include any other types of models or, further, any other types of automatic speech recognition technologies or algorithms.

In some embodiments, the speech recognition module 507 can include and employ a number of different speech recognition models (e.g., machine-learned speech recognition models). As one example, a different model can be associated with and used for each speaker.

As another example, a different model can be associated with and used for each different text source with which the device 101 is programmed to operate. For example, a speech recognition model (e.g., machine-learned speech recognition model) can be trained on training data that is specific to a particular set of one or more text sources. In particular, in some embodiments, a speech recognition model that is specific to a particular text source can be trained using positive training examples, where each positive training example includes an audio signal that corresponds to one of the phrases included in the particular text source. For example, each audio signal can be labelled with a transcription of the phrase to which the audio signal corresponds. As another example, in some embodiments, a speech recognition model that is specific to a particular text source can be trained using negative training examples, where each negative training example includes an audio signal that corresponds to one of the special effects that will be caused during reading of the particular text source. Thus, the speech recognition model can be specifically trained to reject or otherwise ignore special effect sounds that the system will hear during reading of the text source.

In some embodiments, the speech recognition module 507 (e.g., a speech recognition model included therein) can be trained or otherwise configured to look only for phrases that are contained in a particular set of one or more text sources. Thus, in one example, a certain text source may contain approximately 300 phrases, and the speech recognition module 507 can be configured to look only for these 300 phrases, rather than a more typical vocabulary of over 50 thousand words. In some embodiments, the corpus of phrases associated with one or more text sources can be loaded from memory and provided to the speech recognition module 507 at a time at which the user identifies a particular text source that the user will be reading.

Reducing the search/recognition space of the speech recognition module 507 in this manner can have a number of benefits. As one example, speech processing speed can be reduced (e.g., to around 200 milliseconds latency) because the number of potential words to match against or otherwise recognize is greatly reduced. Reduced latency can improve user enjoyment as the special effects can be provided more quickly once the trigger phrase is recognized, thereby allowing improved alignment between the special effects and the corresponding phrase.

For these embodiments, reduced latency may provide advantages when including special effects such as animation or video content. Additionally, certain embodiments of the disclosure can include queuing the animation or video content or otherwise initiating a remote communication channel to (e.g., a Bluetooth connection) based in part on the potential words or phrases. By initiating the communication channel before the trigger word is recited, embodiments of the disclosure can provide an advantage by reducing latency and thereby improving the user experience.

As another example benefit, user privacy can be improved since the speech recognition module 507 will not recognize any user speech (e.g., side or “free form” conversations that occur during reading of the text source) that exceeds the phrases included in the text source. As yet another example benefit, the accuracy of the speech recognition module 507 can be improved since phrases outside the scope of the text source will not be recognized, thereby reducing the number of incorrect recognitions and corresponding false positive effects the module 507 performs/causes.

According to another aspect of the present disclosure, in some embodiments, an output of the speech recognition module 507 can be biased toward a set of expected phrases that are expected to be uttered by the speaker or otherwise heard by the device 101.

As one example, the electronic device 101 can determine a current position of a speaker within a text source and can identify a set of expected phrases expected to be uttered by the speaker based at least in part on the current position of the speaker within the text source. For example, the set of expected phrases can be a subset of all phrases included in the text source.

Generally, the set of expected phrases can include any number of phrases that are expected to be heard based on the current position of the speaker. As one example, the set of expected phrases can include (e.g., exclusively include) a next phrase or next word that comes immediately subsequent to the current position of the speaker. As another example, the set of expected phrases can include (e.g., exclusively include) phrases or words that are on a same page associated with the current position of the speaker. As yet another example, the set of expected phrases can include (e.g., exclusively include) phrases or words that are within a predefined range of positions associated with the current position.

By biasing an output of the speech recognition module 507 toward the set of expected phrases, the recognition accuracy of the speech recognition module 507 can be improved. That is, by leveraging knowledge of the current position of the speaker (e.g., as a result of per-phrase tracking), the speech recognition module 507 can be aware of which phrases should be verbalized next, and can preferentially recognize such phrases with improved accuracy. Furthermore, biasing an output of the speech recognition module 507 toward the set of expected phrases also improves user privacy as extraneous conversation not related to the text source is less likely to be recognized.

In some embodiments, biasing the output of the speech recognition module 507 toward the set of expected phrases can include generating, by the speech recognition module 507, an initial output and then further analyzing or otherwise intelligently handling the initial output based on the set of expected phrases. As one example, the initial output can include a plurality of hypothesized phrases. For example, the speech recognition module 507 can receive an audio signal and then output a plurality of hypothesized phrases that the module 507 hypothesizes the audio signal corresponds. In some embodiments, the speech recognition module 507 can include a bias layer that further analyzes or otherwise intelligently handles the initial output based on the set of expected phrases.

In some embodiments, the speech recognition module 507 can select one of the plurality of hypothesized phrases based at least in part on the set of expected phrases. As one example, the speech recognition module 507 select a first hypothesized phrase that is included in the set of expected phrases. For example, the speech recognition module 507 can compare the set of hypothesized phrases against the set of expected phrases and can select, as the output of the speech recognition module 507, the first phrase that is included in both the set of hypothesized phrases and the set of expected phrases.

In some embodiments, the initial output from the speech recognition module 507 can further include a plurality of confidence scores respectively associated with the plurality of hypothesized phrases. In some of such embodiments, the speech recognition module 507 can identify a subset of the hypothesized phrases that are included in the set of expected phrases and select the hypothesized phrase that has the largest confidence score in the subset of the hypothesized phrases.

As another example, after generating the initial output of the hypothesized phrases and their respective confidence scores, the speech recognition module 507 can increase the confidence score of any hypothesized phrase that also included in the set of expected phrases. Thus, any hypothesized phrase that is also included in the set of expected phrases can get a “boost” in its confidence score. After increasing the confidence score of any hypothesized phrase that is included in the set of expected phrases, the speech recognition module 507 can select the hypothesized phrase that has the largest confidence score. Thus, while expected phrases get a boost in their confidence scores, in some instances, a hypothesized but not expected phrase can still be selected if its initial confidence score is significantly larger than hypothesized and expected phrases. In some embodiments, the speech recognition module 507 can increase the confidence score of each expected phrase by the same amount. In other embodiments, the speech recognition module 507 can increase the confidence score of each expected phrase by an amount that is a function of a distance of the expected phrase from the current position of the speaker. For example, a very next phrase can receive a relatively larger boost than a second-to-next phrase, and so on.

As described above, in some embodiments, the speech recognition module 507 can include a machine-learned speech recognition model. In some embodiments, the machine-learned speech recognition model can be or have been trained to preferentially recognize phrases that match a set of input text provided to the machine-learned speech recognition model at an inference time at which the machine-learned speech recognition model recognizes the phrases. Stated differently, at inference or recognition time, the machine-learned speech recognition model can receive an audio signal and a set of input text as input. The machine-learned speech recognition model can recognize phrases in the audio signal, with a bias toward phrases that are also included in the set of input text.

Thus, in some embodiments, the speech recognition module 507 can input the set of expected phrases as an additional input to the machine-learned speech recognition model alongside audio data to be recognized by the model. As such, at each instance of speech recognition, the speech recognition module 507 can identify a respective set of expected phrases and provide data descriptive of the respective set of expected phrases to the speech recognition model.

A reader's experience may further be enhanced through periodic or sporadic updates, changes, and/or other special effect track alterations. For example, according to embodiments of the present disclosure, operators may be able to access the server 501 to provide additional special effect tracks, add, or otherwise modify existing special effect tracks to text sources. A user or reader of a text source may then download or otherwise obtain the updated special effect track for a selected text source. As such, the reader may experience different special effects than a previous time the user has read the text source. One or more of the special effect tracks may be modified in other ways as well, adding to the dynamic capabilities of embodiments discussed herein. For example, trigger words of a special effect track may be changed, added, removed, or otherwise modified for the same text source. The special effect track may also be modified by changing a special effect elicited by the same trigger word. Such modifications can be performed remotely by an operator, such as via the server 501 and the database 509.

Modifications can also be performed through implementation of a random number generator associated with the system 100. For example, the random number generator may seemingly randomly generate numbers corresponding to one or more trigger words to be used with the text source, a particular special effect to be used in response to a trigger word, and any other aspect of the special effect track to provide the reader or user with a potentially different experience. As another example, the aforediscussed modifications of trigger phrases, sounds, and the like can be effected through a pre-programmed sequence. For example, the first time the text source is read, one set of trigger words are used, the second time, another set is used, and a subsequent time, another set is used, and so on. Further, special effects can be programmed to sequentially change as well. Even still, any other aspect or combination of the same can be programmed to be sequentially modified. Accordingly, different experiences can be had each time a text source is read.

In some embodiments, the electronic device 101, for example, via a speech recognition algorithm, can listen for trigger phrases output by sources other than the user, such as, for example, a TV show, a movie, radio, internet content, and the like). Upon reception of a matched trigger phrase, associated content may be displayed on the electronic device 101. For example, a user may be watching television, and a BMW commercial plays. The system 100 may have a pre-determined trigger phrase for detection of a portion of the BMW commercial. When the system 100 detects the phrase from the BMW commercial, associated content (e.g., an associated advertisement) from BMW may appear on the electronic device 101. Further, the user may click, or otherwise select the advertisement from the electronic device 101 and receive more content pertaining to BMW.

In some embodiments, the speaker 513 may be distanced, or otherwise decoupled from the microphone. For example, the speaker 513 may be communicably coupled to the electronic device via a Bluetooth, NFC, or any other wireless or wired means capable of allowing for communication between the speaker 513 and the microphone. Such a configuration may ensure the microphone of the system 100 picks up audible messages spoken by the reader and not audible effects output by the speaker 513. The system 100 may also employ one or more filters to filter or otherwise block the output audible effects from the speaker 513. Such filtering may be possible due at least in part to the fact that the system 100 knows which audible effects are currently being output. As such, one or more filters knows exactly what audible sounds need to be filtered.

In some embodiments, the electronic device 101 can activate an acoustic echo prevention system or technique, but without attenuating an audio output of the system 100 (e.g., of the speaker 513). The acoustic echo prevention technique can include acoustic echo suppression (AES), acoustic echo cancellation (AEC), and/or line echo cancellation (LEC). This can reduce the amount of the audio signal collected by the electronic device 101 that corresponds to playback of the special effects, thereby isolating the speaker's utterances.

The system 100 may include a communication network 514 which operatively couples the electronic device 101, the server 501, and the database 509. The communication network 514 may include any suitable circuitry, device, system, or combination of these (e.g., a wireless or hardline communications infrastructure including towers and communications servers, an IP network, and the like) operative to create the communication network 514. The communication network 514 can provide for communications in accordance with any wired or wireless communication standard. For example, the communication network 514 can provide for communications in accordance with second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, the communication network 514 may be configured to provide for communications in accordance with techniques such as, for example, radio frequency (RF), infrared, or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, Bluetooth™, ultra wideband (UWB) and/or the like.

The electronic device 101 may refer to, without limitation, one or more personal computers, laptop computers, personal media devices, display devices, video gaming systems, gaming consoles, cameras, video cameras, MP3 players, mobile devices, wearable devices (e.g., iWatch by Apple, Inc.), mobile telephones, cellular telephones, GPS navigation devices, smartphones, tablet computers, portable video players, satellite media players, satellite telephones, wireless communications devices, or personal digital assistants (PDA). The electronic device may also refer to one or more components of a home automation system, appliance, and the like, such as AMAZON ECHO. It should be appreciated that the electronic device may refer to other entities different from a toy such as a doll, or a book.

The system 100 can have a number of different applications and uses. One example described throughout the present disclosure is the presentation of audio special effects in response to reading of a text source such as a book. However, many various and different applications and special effects are possible, some additional examples of which will now be described in further detail.

In some embodiments of the present disclosure, the special effects caused by the system 100 (e.g., output by one or more special effect modules 104) can include visual content such as animated and/or video content. For example, the animated and/or video content can be provided on a display screen, a projector, or other visual presentation devices. As examples, the animated and/or video content can be included in a slide of a number of slides in a slide deck or can be a clip played in association with (e.g., a sequence of) other clips. In some instances, the visual content is not animated or video content but instead consists of one or more still images.

Thus, in one example application, a user can give a presentation and certain phrases that are planned to be included a script of the presentation can be associated with different visual effects such as, for example, presentation of a particular slide within a slide deck. As such, when the user gives the presentation and recites a particular trigger phrase, the presentation can jump to the corresponding slide of the deck (or other content or effect(s)). Even if the user recites the phrases “out of order”, the system 100 can still recognize each phrase and jump to the appropriate slide of the deck. This can be particularly powerful for an interactive presentation and/or a question and answer session.

However, because visual content such as animated and/or video content requires a significant amount of memory space or other data storage formats (e.g., a video can include around 1 GB of data) and may, in some embodiments, be stored at a remote storage location, aspects of the present disclosure are directed to resolving the issue of how to provide an ultra-low latency experience. Some embodiments resolve this issue by using the electronic device 101 as a remote controller for another system that handles content playback. For example, the electronic device 101 can process all of the received speech locally (e.g., as illustrated in FIG. 5). After processing the user speech to determine a position of the speaker within the text source, the electronic device 101 can transmit data descriptive of the position of the speaker to another computing device or system (e.g., the server 501) which can cause playback of the visual content based on the position of the speaker. In such fashion, the speech data does not need to be communicated across a network, but instead only the position data, which represents only a very small amount of data. Thus, the system can perform local speech processing but remote content playback, with only a tiny amount of data descriptive of the position of the speaker needing to be transmitted over a network. In other instances, the position is not communicated to another separate device but instead to another separate application within the electronic device 101 (for example, a first application can handle speech recognition while a second, different application handles special effect playback).

The device 101 and/or the other device, system, or application (e.g., the second application and/or the server 501) can store all visual content assets (e.g., files) locally or can stream the visual content assets from a database or other data source. In some embodiments in which visual content is streamed, the next expected portions of the visual content (e.g., the next expected scene out of a number of possible scenes) can be pre-buffered. In some embodiments that include visual content with corresponding audio content (e.g., audio of events occurring in the visual content) the audio can run asynchronously to the video content. For example, the audio content may not have a defined sequential timeline but instead may include portions that are respectively associated with different scenes such that the audio that is played back is determined based on which visual content is played, rather than a position along an audio timeline.

In another example application, the systems and methods described herein can include support for multiple speakers that cooperatively recite the text source. For example, the speakers can be co-located (e.g., in the same room or vicinity) or can be remotely located from each other (e.g., in different locations and connected via computing devices over a network). In one example, two parents (e.g., two speakers) can be in the room reading a book to a child. In another example, a first parent can be in the room reading the book to the child while a grandparent can be in a different location (e.g., a different city) and can participate in reading the book remotely. For example, a videoconference and/or audioconference feature (e.g., included in a same computing application that implements the special effects system or in a separate computing application) can be implemented by the computing device 101 (or a related device), to permit the grandparent to participate in reading of the book.

As one example possible application for multiple speakers, the systems and methods of the present disclosure can perform speaker recognition in combination with role and/or character assignment. For example, a text source may include portions that are assigned to different roles or characters. For example, a first set of phrases (and corresponding positions) within a text source can be assigned to or otherwise associated with a first character (e.g., a giraffe) while a second set of phrases (and corresponding positions) within the text source can be assigned to or otherwise associated with a second character (e.g., a lion), and so on for any number of different roles or characters. In some embodiments, the first set of phrases can be treated as a separate text source from the second set of phrases and the device 101 can perform separate position tracking respectively for the first and second sets of phrases in parallel. In other embodiments, the different sets of phrases can be treated as a single text source and the phrase information associated with the text source can be annotated with labels defining to which (if any) of the different characters a particular phrase is associated.

The systems and methods of the present disclosure can use this information in a number of different ways. In one example, different voice processing models can be used for each speaker, with each model for each speaker being specific to and/or based on voice data associated with such speaker. In another example, speaker recognition can be applied to recognize which speaker is speaking. The recognition of a particular speaker can be used to disambiguate or otherwise process the speech in an improved manner. For example, if a given speaker is associated with the giraffe character and begins to speak, the device 101 (e.g., the speech recognition module 507) can process the received speech against phrases associated with the giraffe character. Stated differently, the device 101 (e.g., the speech recognition module 507) can be biased toward recognizing phrases that are associated with a character or role that is associated with a recognized speaker.

In another example, in some instances multiple speakers are located in different locations and their speech can be captured using different sensors and/or carried across different channels. As an example, a first parent may be located in room and their speech may be captured by a local microphone and carried on a first channel associated with the local microphone; while a grandparent may be remotely located, and their speech may be captured by a remote microphone and carried on an alternate channel associated with a videoconference application by which the grandparent is participating in the reading of the text source. In some of such embodiments, the association between a speaker and a particular channel can be used to disambiguate or otherwise process the speech in an improved manner. For example, if a given speaker is associated with the giraffe character and speech data is received from the channel associated with such speaker, the device 101 (e.g., the speech recognition module 507) can process the received speech against phrases associated with the giraffe character. Stated differently, the device 101 (e.g., the speech recognition module 507) can be biased toward recognizing phrases that are associated with a character or role that is associated with the channel on which the speech data being processed was received.

In another example application, certain portions of a text source may be user-read portions while other portions of the text source can be computer-read portions. As one example, a user can participate in a system in which they play the role of a particular character (e.g., a character from a well-known movie). The user can speak the lines of their character while the computing system 100 causes effects which include the lines and/or depictions of other characters or other content included within a scene. Thus, in one example, a user can pretend to be their favorite movie character in a virtual reality system and can read the lines associated with the character. In between the lines of the user's character, the virtual reality system can cause playback in the virtual world of the corresponding portions of the scene. Thus, the playback of the scene can be dictated by and timed as a function of the user participating through speech of the user's character's lines.

In another example application, the systems and methods of the present disclosure can be applied to games that include particular identifiable objects such as particular cards or other game pieces. For example, a card or other game piece may correspond to a character, item, action, and/or rule that can be played within the game. As an example, a card might correspond to a particular character or item that a player can deploy during a “battle” against an opponent (e.g., a human opponent or an AI opponent). In some embodiments, the cards or game pieces are not physical pieces but are simply actions or objects that can be taken or played within the game, without necessarily having some physical component being played.

In some embodiments, the system 100 can cause certain special effects (e.g., audio effects, lighting effects, etc.) to occur when different cards or other game pieces are played within the context of the game. As one particular example, a player can play a game card that corresponds to a character that shoots lighting (e.g., a character named “Green Lightning”). The player can announce that he is playing the particular card, including announcing the name of the character or some other identification of the card (e.g., “I summon ‘Green Lightning!’”). The device 101 (or other system component) can recognize the name of the character or other identification of the card as announced by the player and, in response, cause playback of one or more special effects associated with the card or character. As one example, in response to recognizing that the player has announced playing of the Green Lighting card, the device 101 can cause audio to be played that includes the sounds of lightning and thunder and/or can cause a visual effect such as lights flashing to simulate lightning. In another example, the character can be shown on a display screen (e.g., an animation of the character). In such fashion, special effects can be added to supplement a game that includes cards or other game pieces, thereby enabling a more enveloping, multi-sensory game play experience. Recognition of card identifiers can be performed using, for example, keyword spotting techniques.

In some embodiments, the player may also need to announce or otherwise speak an introductory word that alerts the device 101 that the following speech should be processed to recognize a card or other game piece or game action. For example, the player can say “I summon”, “I cast”, “I play”, or some other introductory phrase that precedes the phrase that will trigger the special effects. In some implementations, the introductory phrase can be user customized. In some implementations, different introductory phrases can lead to different special effects, for example, a player announcing “I summon Green Lightning” can result in lightning sounds while a user announcing “I capture Green Lightning” can result in the sound of the character being captured.

In some embodiments, different special effects can be assigned to the same game pieces depending on a game state of the game. For example, the audio special effect associated with the “Green Lightning” character can grow weaker sounding as the character loses strength due to gameplay. In some embodiments, different special effects can be unlocked as part of gameplay. For example, if a player achieves a certain level or game state, the special effects associated with a card or game piece can change. For example, if a player achieves a level in which they are playing in a cave, the audio special effects caused by playing a game piece can include echo sounds. Alternatively or additionally, different special effects can be provided as rewards to players in the game.

In some embodiments, there may be different types or categories of different cards or game pieces. As examples, cards might be divided into land cards and action cards. For example, land cards can be played to change a level or setting in some way. In some embodiments, the special effects caused by playing a land card can be played in the background and/or looped. For example, if a user states “I play the ‘Deserted Island’”, the system can cause soft ocean and wind sounds to play on a loop in the background (e.g., until another, different land card is played to change the level or setting). In contrast, for example, the special effect(s) associated with an action card may simply occur once and then cease.

In some embodiments, in addition or alternatively to speech recognition, computer vision can be used to recognize cards or game pieces as they are played. This may, for example, enable recognition of different versions of the same card that have different visual characteristics. For example, different versions of the same card might include a collector's edition special card that has a metallic sheen. The different versions of the same card can have different special effect(s) respectively associated therewith. Alternatively or additionally, different versions of the card can be announced or otherwise verbalized to enable recognition.

In some embodiments, a user can customize the different effects associated with each of the cards or other game pieces that he owns (e.g., that are within his “deck”). For example, a user can interact with computer software to assign different effects (including user-generated effects) to certain cards. Speaker recognition can be performed to recognize which player is playing a certain card or game piece and, in response, a player-specific set of effects can be caused. Thus, speaker recognition can be used to identify the appropriate effect(s) to perform in response to playing of a card that multiple player may own.

In some embodiments, aspects of the present disclosure can be applied to games that include both linear events and non-linear events. In some embodiments, different forms of speech processing can be performed for different aspects or portions of the game. For example, for the general domain text of a game, the device 101 can perform the positional tracking techniques described herein. On the other hand, for special player cards or statements, keyword spotting can be performed. Thus, for mixed linear and non-linear events, each type of speech processing may be active or inactive depending on the current game location and/or game state.

In some embodiments of the present disclosure, the occurrence and/or synchronization of the special effect can include one or more Internet of Things (IoT) connected devices included in the system and/or in communication with the system. For example, a system could include a first device (e.g., the device 101) or component for performing the positional tracking and a second device or component for communicating with the IoT device(s) (e.g., a lamp, a fan, a heating/air system, a sprinkler, a fireplace, a computer, and a TV.)

In some embodiments, the second device can be a “smart speaker” or “home assistant” which applies rules to identify certain IoT devices that are capable of being controlled to perform certain actions (e.g., actions that were generically specified to the second device by the first device using an application programming interface (API)). For example, the first device (e.g., device 101) can simply indicate to the second device the operation of DIM_LIGHTS. The second device can receive the operation and can identify certain IoT devices (e.g., using a manifest of connected IoT devices that are capable of performed the requested operation. The second device can communicate with the identified IoT devices to accomplish the requested operation. Thus, existing control structures within a smart home can be leveraged by using the smart speaker or home assistant as an intermediary that is capable of receiving generic special effect requests and effectuating them with specific devices or structures within the home or control group. However, in another example, the first device can perform both the positional tracking and handle communication with the IoT devices.

Thus, individual operations described in this disclosure may be performed on a single device or on multiple devices in communication. Additionally, the communication with the IoT device(s) can trigger special effects by starting, stopping, or otherwise modifying an operation of an IoT connected device (e.g., adjusting the speed of a fan or the brightness of a light). For example, in response to recognition of a reader reading a novel that talks about the sun setting, the device 101 may cause one or more IoT connected lamps to dim and turn off as the reader progresses through the portion of the book.

In some implementations, the first device can communicate with the second device and/or the one or more IoT devices using ultrasonic communication. For example, the ultrasonic waves encoding the communications between the devices can be treated as audio files that can be stored and then played back (e.g., by a speaker) when appropriate. As one example, a user can read the phrase “and then the sun set,” and the corresponding special effect includes dimming the lights. As such, in response to recognizing the trigger phrase “and then the sun set,” the device 101 can cause playback of an ultrasonic signal that encodes communications to a smart lamp. The smart lamp can perceive the ultrasonic signal and decode it to comprehend the instruction and, in response, dim the lamp's light.

In certain embodiments of the present disclosure, the determination of whether to cause occurrence of a special effect can also be based in part on a status, such as the position in a text source or the state of a non-linear text (e.g., a turn-based card or board game). For example, a character could have a phrase that is repeated throughout a text source, and as a reader progresses through the text source, the special effect could change based on the position of the reader in the text. As another example, a game could include a leveling mechanism where each player recites, or the game tracks a player level at each turn or when a new level is achieved. As the player level increases, the type of special effect triggered by the same word or phrase could change, thus players could unlock new special effects as gameplay advances. As an example, a level 1 player casting fireball could only result in an explosion noise, while a level 3 player casting fireball could result in an explosion noise and one or more lights flickering. As another example, the round of a game, the chapter of a book, or the act of a play could be used to determine the status to adjust the special effect. Further, it should be recognized that the status, need not only apply to repeated words or phrases, a reader could unlock new trigger words or phrases by reaching new status in the text source.

In another aspect, a system for providing a special effect associated with an auditory input can be included as part of a toy or other device containing instructions for initiating the special effect. As an example, the system can be included as part of a wand in a wizarding game, the wand containing the speech recognition system and a communication system that can interact with a remote device or devices. Alternatively or additionally, the speech recognition system can be included as part of a downloadable application for use on a smartphone, tablet, or other computing device. Thus, in some embodiments, speech may be recorded at the toy (e.g., wand) and then transmitted to the application on the other device for processing.

In some examples, the wand or other toy can be part of an interactive game (e.g., laser tag or similar) having a set of rules that includes spells that a player can cast. Upon the player pointing the wand and reciting a spell name, a special effect can be triggered. The type of special effect triggered can be based on multiple factors that include but are not limited to the accuracy of the pronunciation (e.g., the number of syllables correct), the aim or position of the device (e.g., the wand), and/or the location of the player (e.g., outside or inside). For each of these different factors, the special effect triggered can be different (e.g., a player pronouncing less than 2 syllables correct produces a “dud” noise, a player pronouncing 3 syllables correct produces a “firecracker” noise, and a player pronouncing more than 3 syllables correct produces an “explosion” noise.) Thus certain embodiments of the disclosure may include a speech recognition device configured to recognize and/or distinguish a similar but incorrect word.

As an example, recognizing and/or distinguishing a similar but incorrect word can include using information such as a confidence score output by a recognition algorithm as a proxy for pronunciation. For example, the trigger word can include a multi-syllabic word such as “abracadabra” which can have 5 syllables (i.e., ab-ra-ca-dab-ra.) One aspect of determining the confidence score can be the number of syllables pronounced by the speaker, so an example embodiment may be configured to generate a lower confidence score for a speaker reciting the first 4 syllables and a higher confidence score for a speaker reciting all 5 syllables in the correct order. Alternatively, the confidence score can be an indication of how confident the speech recognition algorithm is that the received speech matches the predicted phrases that the speech recognition algorithm has “recognized”. Using this information, an example system can be configured to determine the special effect based at least in part on the confidence score. As an example implementation, a lower confidence score could trigger only a noise effect (e.g., firework noises), a moderate confidence score could trigger the noise effect and a visual effect (e.g., firework noises and lights flickering), and a higher confidence score could trigger the noise effect, the visual effect, and an environmental effect (e.g., firework noises, lights flickering, and space heater started).

Likewise, as discussed elsewhere herein, various effects can be caused to be performed by various other remote devices. For example, if the user speaks a spell which is heard and processed by the wand, the wand can communicate with a remote animatronic system (e.g., at a theme park) to cause the remote animatronic system to perform a special effect. Thus, in one example, a user can walk about a theme park and can cast various spells (or other verbal cues) at different exhibits. If the user's spells (or other verbal cues) are recognized, they may cause various system or events at the theme park to operate. For example, the user can enter a wizard theme park area in which the user can cast spells to cause different demons to fly away or other audio or visual effects to occur within the park area.

Additionally or alternatively, the first device or second device can include a second machine learning algorithm. In an embodiment, the first device or the second device can be configured to receive data such as visual information related to the text source or the position of the reader in the text source (e.g., the current page, the current card, or the current game state.) For these implementations, the first device, the second device, or a third device in communication with one or both of the first device and the second device can include a camera, a machine learned algorithm, a training dataset, or any combinations thereof. Further, systems including one or more devices can be used to determine or otherwise bias a set of expected phrased based in part on an output of the second machine learning algorithm. In some instances, the output from the second machine learning algorithm can be used to set or to determine a parameter for the computing systems disclosed herein (e.g., a special effect layer). As an example, in a card game, a player may cast a card into the playing area that has a special finish (e.g., a holographic finish.) The computing system can recognize the special finish based in part on the output of the second machine learning algorithm and set the special effect layer to a holograph special effect layer, instead of the regular special effect layer. Thus, for certain embodiments the resultant special effect produced by the system can be adjusted based on visual information in addition to audio information provided by a speaker.

In the description herein throughout, the term “app” or “application” or “mobile app” may refer to, for example, an executable binary that is installed and runs on a computing device, or a web site that the user navigates to within a web browser on the computing device, or a combination of them. An “app” may also refer to multiple executable binaries that work in conjunction on a computing device to perform one or more functions. It should be noted that one or more of the above components (e.g., the processor, the speech recognition module 507) may be operated in conjunction with the app as a part of the system 100.

The various illustrative logical blocks and modules described herein may be implemented or performed with a general-purpose processor, an application specific integrated circuit, (ASIC) a digital signal processor, a field programmable gate array (FPGA) or other programmable logic device, discrete gate or transistor logic, discrete hardware components, or any combination thereof. A general-purpose processor may be a microprocessor, but in the alternative, the processor may be any conventional processor, controller, microcontroller, or state machine. A processor may also be implemented as a combination of computing devices, e.g., a combination of a digital signal processor and a microprocessor, a plurality of microprocessors, one or more microprocessors in conjunction with a digital signal processor core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a computing device. In the alternative, the processor and the storage medium may reside as discrete components in a computing device.

In one or more exemplary designs, the functions described may be implemented in hardware, software, firmware, or any combination thereof. If implemented in software, the functions may be stored on or transmitted over as one or more instructions or code on a computer-readable medium, and preferably on a non-transitory computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

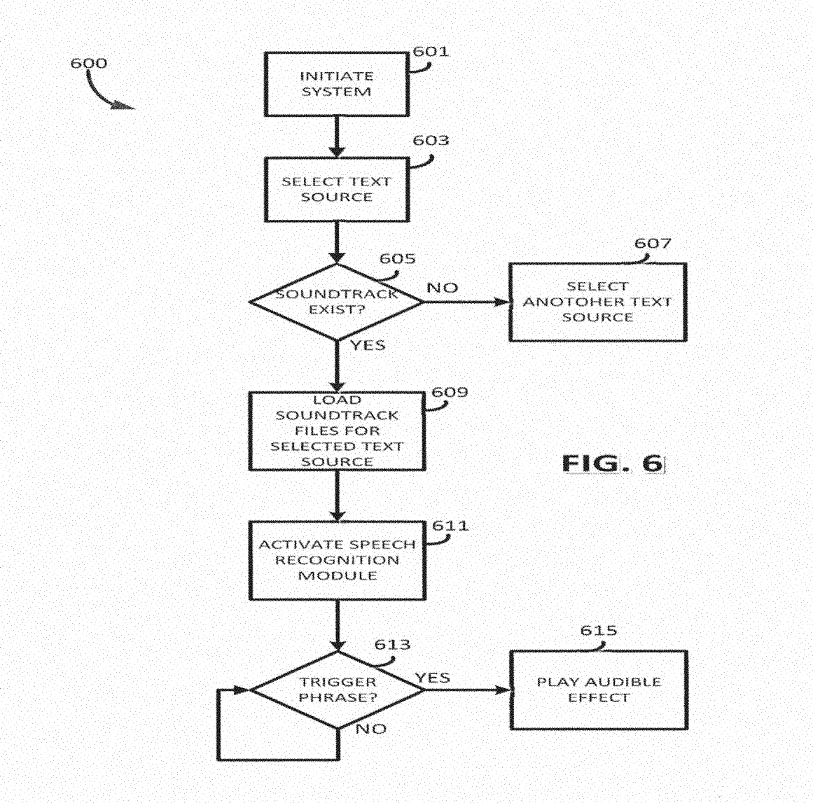

FIG. 6 is an example flow diagram 600 illustrating operation of one of the embodiments of the present disclosure. At block 601, a user may initiate the special effect system 100. Such initiation may take the form of logging onto an associated application on the electronic device 101. After initiation of the system 100, at block 603, the user may identify a text source she wishes to read aloud. Identification of the text source may be performed by the user entering a title of a text source, browsing for a text source title, or audibly speaking the name of a text source title. Also using the electronic device 101, the user may read a bar code, QR code, or other unique identifying mark on a text source, the title of which may be extracted therefrom, for use with the app. At block 605, the system 100 (e.g., the server 501 or an application running locally) may check if a special effect track exists for the selected text source. If no soundtrack exists, at block 607, the system 100 (e.g., the server 501 or an application running locally) may prompt the user to select another text source for reading. This process may repeat until a text source is selected for which there exists a special effect track, at which time the process continues to block 609. At block 609, one or more special effect track files associated with the selected text source may be loaded onto the electronic device. One of more of the special effect track files may be downloaded (e.g., from the database 509 via the server or the memory 508) to the electronic device 101 (e.g., onto the memory 508). Alternatively, one or more special effect track files, or any portion thereof, may be retrieved from the database via server 501 during reading of the selected text source.

At block 611, the speech recognition module 507 may be activated to receive audible input from the reader, via the microphone of the input unit 503. At block 613, the application continuously picks up on audible messages, checks the audible input for matches to one or more trigger phrases. Such a check may include comparing the spoken word(s) to word searchable files having an associated audio effect or soundtrack. In further embodiments, such a check may include comparing the spoken word(s) to a database of pre-programmed trigger phrases and delivering a numerical confidence score of a keyword being detected. Upon detection (or a score high enough to count as a detection), at block 615, the system 100 plays the special effect associated with the detected one or more trigger phrases. The system 100 continues to listen for audible messages continuously during playing of the special effect(s). The system 100 continues to listen for audible messages until the end of the text source is reached, another text source is loaded, or the system 100 is deactivated.

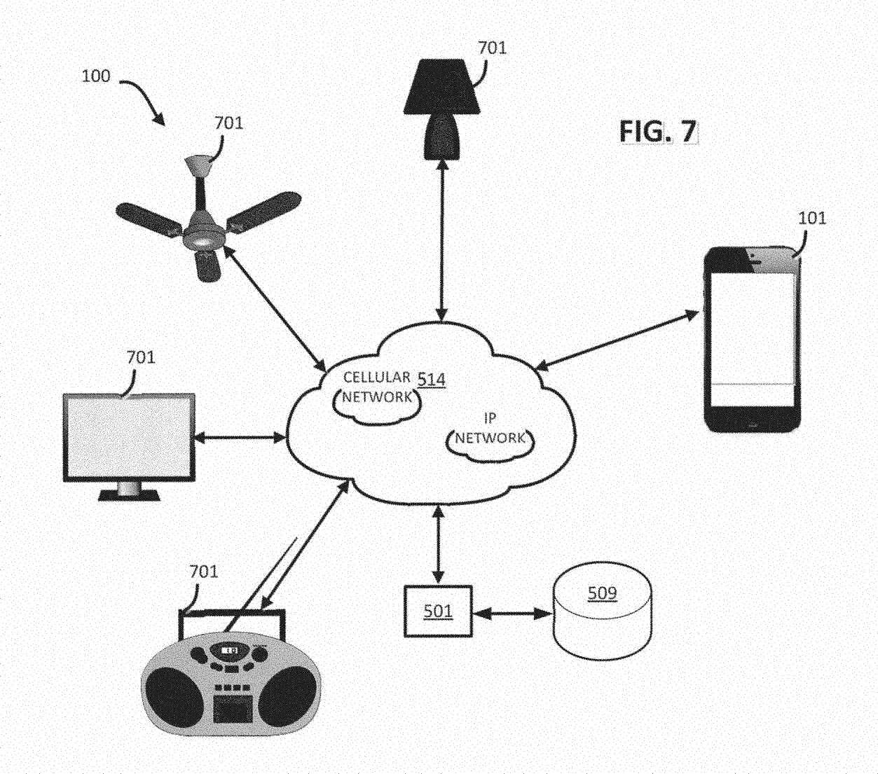

It should be appreciated that other embodiments are contemplated. For example, one or more components of the system 100 may be employed for integration with movie or other media content. For example, the system 100 may be programmed to output special effects in response to audible messages from currently playing media content. These effects may be audible or other forms depending on other connected devices. For example, and as reflected in FIG. 7, the system 100 may be programmed to queue one or more special effects generated by one or more internet of things (IoT) devices 701 which may be embedded with electronics, software, and/or sensors with network connectivity, which may enable the objects to collect and exchange data. For example, these IoT devices 701 may potentially be associated with home automation which may include but are not limited to lights, fans, garage doors, alarm systems, heating and cooling systems, doorbells, microwaves, and refrigerators, that may allow the system 100 to access, control, and/or configure the same to generate a special effect or prompt another IoT device to generate a special effect.

Further, it should be appreciated that the systems, methods, and other embodiments described can include one or more components for delivering instructions through an API or communicating with an outside API. As a non-limiting example use, an embodiment of the disclosure can include a reader delivering a speech associated with one or more visual cues such as slides. An embodiment of the disclosure can include recognizing the reader's position in the speech and triggering a special effect that can include turning on a projector, changing to the next slide, or turning on a music system. In some of these embodiments, the special effect can be triggered by communicating with an external program (e.g., through an API.) Additionally, certain embodiments of the disclosure may provide an advantage to traditional methods, such as timed transitions or a physical device, by reducing multi-tasking (i.e., each special effect can be triggered by the speech alone) which can produce an improved audience experience.

Similar to the above discussed creation of special effect tracks for text sources, operators may create special effect tracks customized for any movie or other media content. Such interactivity with home devices may operate both ways. For example, in response to one or more special effects output by the aforediscussed home devices, media content played from (e.g., a video player), may be controlled (e.g., paused, sped up, slowed down, skipped through, changed) directly through such home devices. Accordingly, one or more embodiments of the present disclosure allow for the communication of objects, animals, people, and the like (e.g., through a network) without human-to-human or human-to-computer interaction.

Embodiments of the present disclosure may also allow for the communication of any of the afore-discussed devices through use of pre-defined audio sources. For example, operators of the system 100 may program audio sources to configure a connected device to operate in a desired manner. The pre-defined audio may be any content, such as television, radio, audiobook, music, and the like. Any connected device within a distance capable of detecting audio from pre-defined audio source can communicate and interact in a predetermined manner.

Certain embodiments of the present disclosure may also relate to advertising. For example, a person may be watching programming (e.g., on a television) and a car advertisement is played. The person may have an electronic device in close proximity. As such, the electronic device (e.g., speech recognition module) may detect the car advertisement through, for example, pre-programmed trigger words that are played during the advertisement. Consequently, the system may be configured to detect that the user is listening to the advertisement in real time. Further, the system may be configured to present (on the electronic device) corollary content, such as another advertisement or other media related to the detected car advertisement that was displayed on the television.

Further, certain embodiments of the present disclosure may relate to data analytics allowing a user of an electronic device to ascertain information about other users and associated electronic device through use of the aforediscussed system. For example, the system may be configured to determine if and when a user has been within an audible distance of an advertisement as discussed above. Such a system can have the words played in the advertisement pre-programmed as trigger words, and thereby determine if and when the trigger words are detected thus signaling that a user has heard the advertisement.

FIG. 8 is an example flow chart depicting an example method 800 of providing special effects for a text source according to example embodiments of the present disclosure. Method 800 can be performed by a computing system such as, for example, the system 100 of FIGS. 1 and 5. For example, some or all of the steps of method 800 can be performed by the electronic device 101.

At 802, the computing system can obtain a script associated with a text source. For example, the computing system can load the script from a local memory or can access the script from a remote data source. In some embodiments, the computing system can obtain the script associated with a particular text source in response to a user input that selects the particular text source (e.g., via a graphical user interface).

At 804, the computing system can obtain audio data descriptive of a human speech utterance. For example, the computing system can include a microphone and can collect the audio data descriptive of the human speech utterance.

At 806, the computing system can perform speech recognition to recognize the human speech utterance. For example, one or more speech recognition techniques (e.g., as described with reference to speech recognition module 507 of FIG. 5) can be performed to recognize the human speech utterance. In some embodiments, recognizing the human speech utterance at 806 can include generating a transcription of the audio data.

At 808, the computing system can identify a phrase included in the human speech utterance. For example, identifying the phrase included in the human speech utterance can include comparing the transcription of the audio data against the script to identify a particular phrase within the script to which the human speech utterance corresponds.

At 810, the computing system can update a position of the speaker within the script based at least in part on the identified phrase. For example, once the phrase has been identified within the script, the computing system can update the current position of the speaker to correspond to the position associated with the recognized phrase.

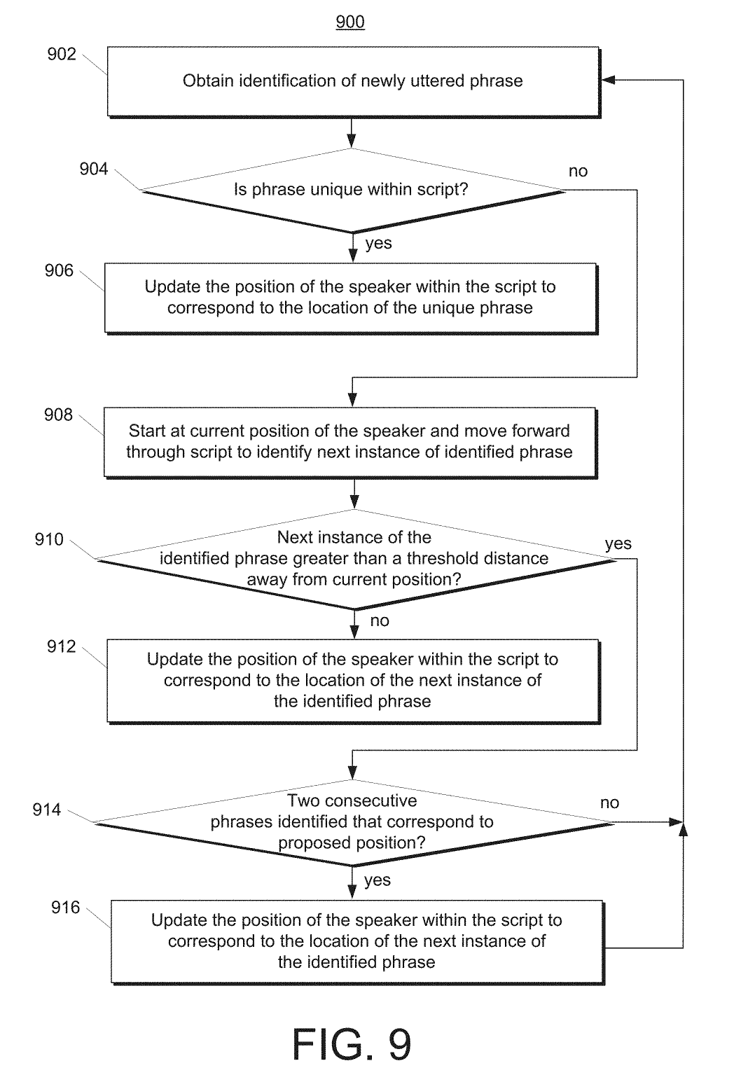

As one example, FIG. 9 is an example flow chart depicting an example method 900 of tracking a position of a speaker within a script. Method 900 is one example method that can be performed, for example, to complete blocks 808 and 810 of FIG. 8.

At 902, the computing system can obtain identification of a newly uttered phrase. For example, a particular phrase can be identified as having been included in the audio data of the human speech utterance. As described elsewhere herein, the phrase can correspond to a contiguous sequence of n items from the text source. The items can be characters, phonemes, syllables, or words. In some example embodiments, some (e.g., most) or all phrases included in a text source can be bigrams.

At 904, the computing system can determine whether the identified phrase is unique within the script. For example, the script can be search to determine whether the identified phrase occurs once within the script or more that once within the script. To provide one simplified example with reference to the example script of FIG. 15, the phrase “teach” occurs only once and is unique while the phrase “my dog” occurs twice and is not unique.

If it is determined at 904 that the phrase is unique within the script, then method 900 can proceed to 906. At 906, the computing system can update the position of the speaker within the script to correspond to the location of the unique phrase. To provide one simplified example with reference to the example script of FIG. 15, if the identified phrase was “teach,” then the computing system can update the position of the speaker to position 3.

However, if is determined at 904 that the phrase is not unique within the script, then method 900 can proceed to 908. At 908, the computing system can start at the current position of the speaker and move forward through the script to identify a next instance of the identified phrase. To provide one simplified example with reference to the example script of FIG. 15, if the current position of the speaker is position 2 and the identified phrase is “my dog,” the computing system can first analyze position 3 and then position 4, etc. The next instance of the identified phrase can be identified at position 4. In such fashion, the current position of the speaker can be leveraged to disambiguate between multiple instances of the same phrase within the script.

In some embodiments, once the next instance of the identified phrase is identified, the computing system can update the current position of the speaker to correspond to the location of the next instance of the identified phrase. However, in other embodiments, the computing system can perform additional steps to ensure that an overly large jump in the current position of the speaker is performed.

In particular, as one example illustrated in FIG. 9, after identifying the next instance of the identified phrase at 908, the computing system can determine, at 910, whether the next instance of the identified phrase is greater than a threshold distance away from the current position of the speaker. As one example, the threshold distance can correspond to ten positions, but many other and different thresholds can be used and, in some instances, the thresholds can dynamically change based on the current position, the text source, the speaker, user settings, etc.

If it is determined at 910 that the next instance of the identified phrase is not greater than the threshold distance away from the current position, then method 900 can proceed to 912. At 912, the computing system can update the position of the speaker within the script to correspond to the location of the next instance of the identified phrase. Thus, if a contemplated adjustment in the current position of the speaker will result in a change in position less than a threshold amount, the adjustment can be performed.

However, if it is determined at 910 that the next instance of the identified phrase is greater than the threshold distance away from the current position, then method 900 can proceed to 914. Thus, if a contemplated adjustment in the current position of the speaker will result in a change in position greater than a threshold amount, additional evidence can be sought from other sources before the adjustment is performed.

At 914, the computing system can determine whether two consecutive phrases have been identified that correspond to the proposed position identified at 908. If it is determined at 914 that two consecutive phrases have been identified that correspond to the proposed position identified at 908, then method 900 can return to 906.

At 906, the computing system can update the position of the speaker within the script to correspond to the location of the next instance of the identified phrase identified at 908, which may correspond to the position of the first and/or second consecutive phrase to be recognized. Thus, for adjustments in the position of the speaker that correspond to large “jumps,” the computing system can wait until two (or more) consecutive phrases that confirm that the jump is appropriate—which can be viewed as a form of “double-checking” the accuracy of the adjustment.

The logic applied at block 914 is one example test that can be applied to confirm the accuracy of adjusting the current position of the speaker. Many other and different tests can be applied in addition or alternatively to the test shown at block 914. For example, rather than require two consecutive phrases, as another example, the computing system can require that the phrase have a length (e.g., three words) that is longer than a threshold length (e.g., two words). As another example, the confidence score associated with the identified phrase can be compared to a threshold confidence value. Furthermore, in some embodiments, the test shown at 914 and/or the like can be applied in any instance in which the position of the speaker is updated, rather than only when the adjustment is a large jump.

Referring again to FIG. 8, after updating the current position of the speaker at 810, the computing system can next determine, at 812, whether one or more special effects are associated with the current position. For example, the script can be consulted to determine whether the current position is labelled with any special effects.

If it is determined at 812 that special effects are not associated with the current position, then method 800 can return to block 804 and again obtains audio data descriptive of human speech utterance. Thus, the position of the speaker can be continually updated on a per-phrase basis, even when no special effects are caused.

However, if it is determined at 812 that one or more special effects are associated with the current position, then method 800 can proceed to 814. At 814, the computing system can cause the one or more special effects to occur. Examples of special effects are described throughout the present disclosure. After 814, method 800 can return to block 804 and again obtain audio data descriptive of human speech utterance.

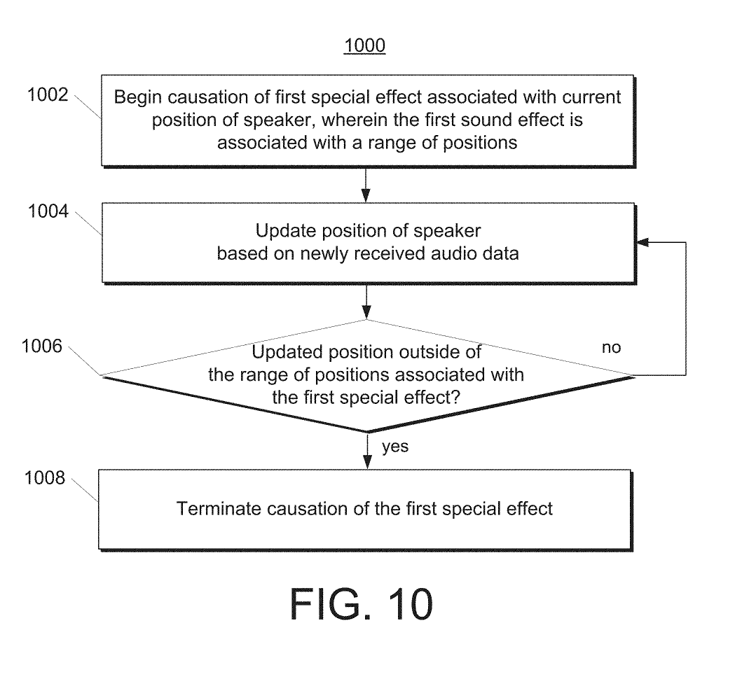

FIG. 10 is an example flow chart depicting an example method 1000 of providing special effects for a text source according to example embodiments of the present disclosure.

At 1002, a computing system can begin causation of a first special effect associated with a current position of the speaker, where the first special effect is associated with a range of positions. As one simplified example with reference to the example script of FIG. 15, if the current position of the speaker is position 6, the computing system can cause occurrence of special effect 4, which is associated with the range of positions 6-8.

At 1004, the computing system can update the current position of the speaker based on newly received audio data. At 1006, the computing system can determine whether the updated position is outside of the range of positions associated with the first special effect.

If it is determined at 1006 that the updated position is not outside of the range of positions associated with the first special effect, then the method 1000 can return to 1004 and again update the current position of the speaker based on newly received audio data.

However, if it is determined at 1006 that the updated position is outside of the range of positions associated with the first special effect, then the method 1000 can proceed to 1008 and terminate causation of the first special effect. Thus, the computing system can continue causing the special effect until a phrase is recognized that is outside of the associated range of positions. This can be useful, for example, for background music special effects.

As one example with reference to FIG. 15, if the current position is updated from position 6 to position 8, then the computing system can continue causation of special effect 4. However, if the current position is updated to position 9, then the computing system can terminate special effect 4.

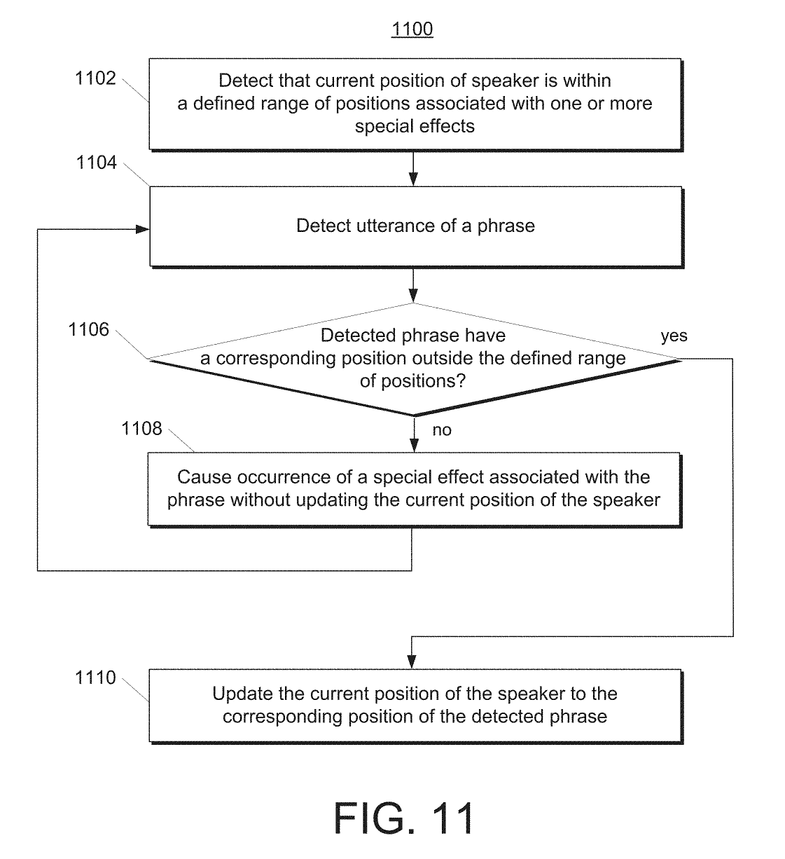

FIG. 11 is an example flow chart depicting an example method 1100 of providing special effects for a text source according to example embodiments of the present disclosure.

At 1102, a computing system can detect that a current position of a speaker is within a defined range of positions associated with one or more special effects. At 1104, the computing system can detect an utterance of a phrase. At 1106, the computing system can determine whether the detected phrase has a corresponding position that is outside the defined range of positions.

If it is determined at 1106 that the detected phrase does not have a corresponding position that is outside the defined range of positions, then method 1100 can proceed to 1108. At 1108, the computing system can cause occurrence of one or more of the special effects that are associated with the phrase without updating the current position of the speaker. After 1106, method 1100 can return to 1104 and again detect utterance of a new phrase.

However, if it is determined at 1106 that the detected phrase does have a corresponding position that is outside the defined range of positions, then method 1100 can proceed to 1110. At 1110, the computing system can update the current position of the speaker to the corresponding position of the detected phrase.

Thus, in some embodiments, once the speaker has entered a range of positions, the current position can simply remain within the range while special effects are performed immediately based on recognition of a corresponding phrase without requiring update of the current position of the speaker. As one example, this scheme can be applied to ranges which include single-word phrases. Thus, the special effect can be caused as soon as the single-word phrase is recognized, reducing the latency at which the special effect is caused, resulting in improved temporal alignment (e.g., reduced delay) between utterance of the single-word phrase and performance of the special effect.

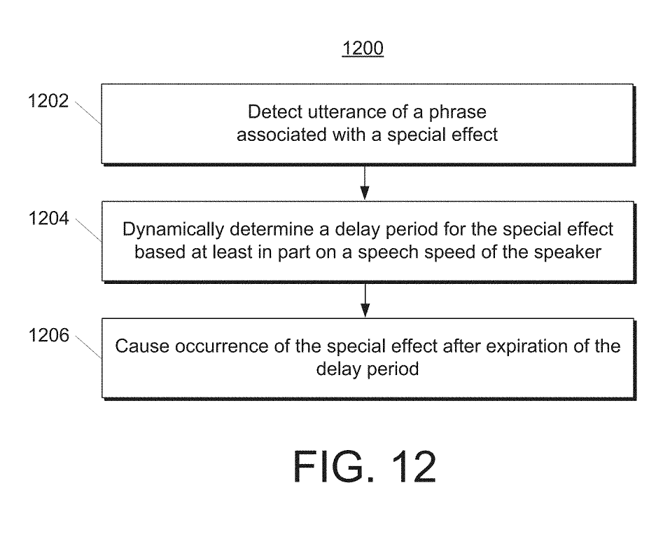

FIG. 12 is an example flow chart depicting an example method 1200 of providing special effects for a text source according to example embodiments of the present disclosure.

At 1202, a computing system can detect utterance of a phrase associated with a special effect. For example, the phrase can be a trigger phrase for the special effect.

At 1204, the computing system can dynamically determine a delay period for the special effect based at least in part on a speech speed of the speaker. For example, the computing system can perform an interpolation to determine an expected time at which a feature phrase will be uttered. In some embodiments, the interpolation can be based on a timestamp associated with utterance of the trigger phrase and the speech speed of the speaker.

At 1206, the computing system can cause occurrence of the special effect after expiration of the delay period. Thus, in some embodiments, the timing of the special effect can be dependent upon the speech speed of the speaker, leading to improved temporal alignment between utterance of a feature phrase and performance of the corresponding special effect.

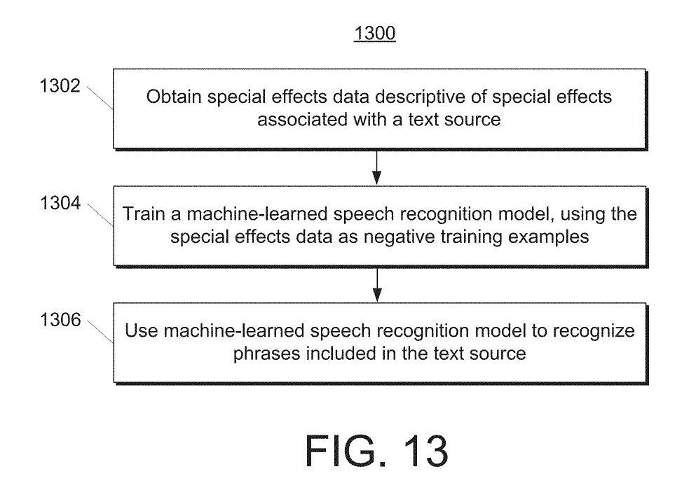

FIG. 13 is an example flow chart depicting an example method of training a machine-learned speech recognition model for improved performance against special effects according to example embodiments of the present disclosure.

At 1302, a computing system can obtain special effects data descriptive of special effects associated with a text source. For example, the special effects data can include a special effects file that includes special effects tracks such as, for example, audio files.

At 1304, the computing system can train a machine-learned speech recognition model. In particular, the computing system can use the special effects data as negative training examples. As one example, the machine-learned speech recognition model can be trained against the audio files for the special effects.

At 1306, the computing system can use the machine-learned speech model to recognize phrases included in the text source. However, as a result of the negative training, the machine-learned speech recognition model can ignore or otherwise reject audio signals collected during reading of the text source which correspond to performance of special effects.

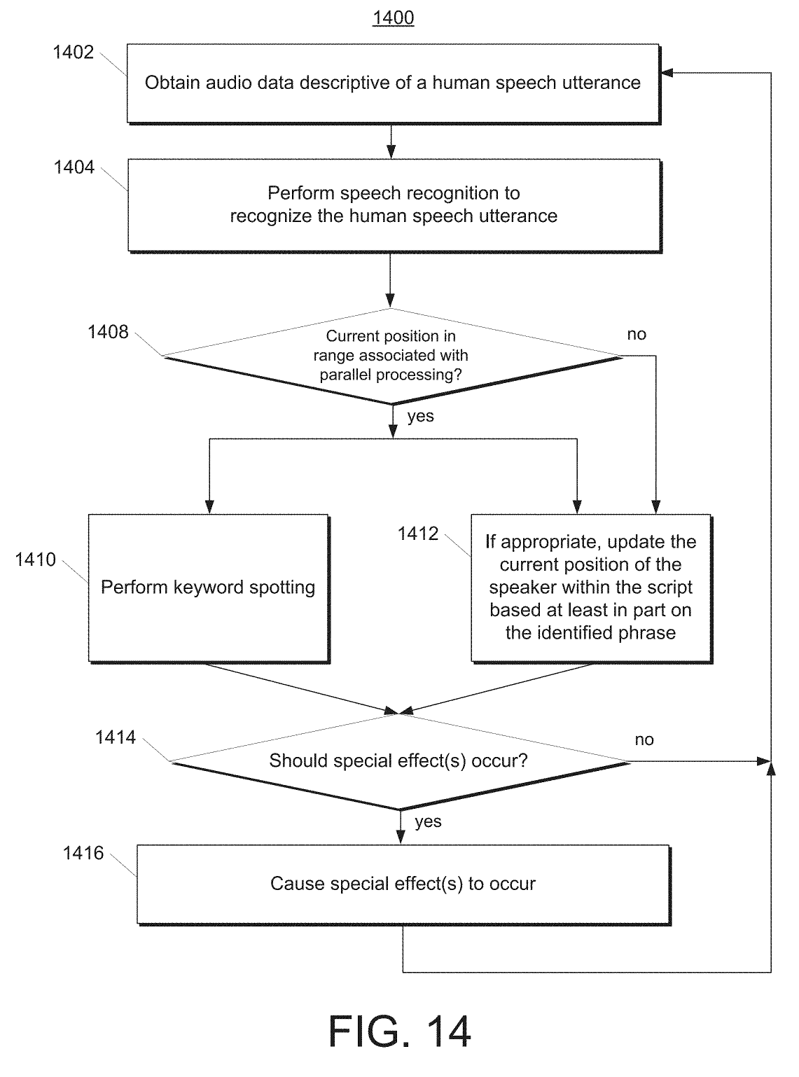

FIG. 14 is an example flow chart depicting an example method of providing special effects for a text source according to example embodiments of the present disclosure.

At 1402, a computing system can obtain audio data descriptive of a human speech utterance. For example, the computing system can include a microphone and can collect the audio data descriptive of the human speech utterance.

At 1404, the computing system can perform speech recognition to recognize the human speech utterance. For example, one or more speech recognition techniques (e.g., as described with reference to speech recognition module 507 of FIG. 5) can be performed to recognize the human speech utterance. In some embodiments, recognizing the human speech utterance at 806 can include generating a transcription of the audio data.

At 1408, the computing system can determine whether a current position of a speaker is within a range of positions that is associated with parallel processing. For example, a script can indicate whether the current position of the speaker is within one or more ranges of positions that are associated with parallel processing.

If it is determined at 1408 that the current position of a speaker is not within a range of positions that is associated with parallel processing, then method 1400 proceeds to 1412.

At 1412, the computing system updates the current position of the speaker within the script based at least in part on the identified phrase, if appropriate. For example, updating the current position of the speaker within the script based at least in part on the identified phrase, if appropriate, can include comparing the transcription of the audio data against the script to identify a particular phrase within the script to which the human speech utterance corresponds. Once the particular phrase, if any, is identified, the computing system can update the current position to the corresponding position provided in the script.

In some embodiments, the current position of the speaker can be updated at 1412 even if the updated position is still within the range of positions. In other embodiments, the current position of the speaker will only be updated at 1412 if the updated position is outside the range of positions.

However, referring again to 1408, if it is determined at 1408 that the current position of a speaker is within a range of positions that is associated with parallel processing, then method 1400 proceeds to both 1412 and 1410.

At 1410, the computing system performs keyword spotting. As one example, performing keyword spotting at 1410 can include comparing the transcription obtained at 1404 to a set of keywords. In some embodiments, if any portion of the transcription matches a keyword that is a member of the set of keywords, then such keyword can have been “spotted”.

In some embodiments, the set of keywords can be associated with and/or specific to the particular range of positions identified at 1408. For example, the set of keywords can include keywords that are expected to be heard given that the current position of the speaker is within the range of positions identified at 1408.

In some embodiments, one or more special effects can be associated with each keyword in the set of keywords. In some embodiments, if a keyword is “spotted”, then the computing system should cause its corresponding special effects to occur.

At 1414, the computing system determines whether special effects should occur based on the output of step 1412 and (if performed) step 1410. As one example, if either the keyword spotting or the current position of the speaker indicates that one or more special effects should occur, then it can be determined at 1414 that such special effect(s) should occur. Thus, in some embodiments, at step 1414, the computing system can apply a logical OR analysis to the outputs of steps 1410 and 1412. In some embodiments, two different special effects can be separately caused based on the respective outputs of steps 1410 and 1412.

However, in other embodiments, at 1414, the computing system determines that a special effect should occur only if both the keyword spotting and the current position of the speaker indicate and agree that one or more special effects should occur. Thus, in some embodiments, at step 1414, the computing system can apply a logical AND analysis to the outputs of steps 1410 and 1412.

If it is determined at 1414 that special effects should not occur, then method 1400 can return to block 1402 and again obtain audio data descriptive of human speech utterance.

However, if it is determined at 1414 that one or more special effects should occur, then method 1400 can proceed to 1416. At 1416, the computing system can cause the one or more special effects to occur. Examples of special effects are described throughout the present disclosure. After 1416, method 1400 can return to block 1402 and again obtain audio data descriptive of human speech utterance.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

In particular, although FIGS. 6 and 8-14 respectively depict steps performed in a particular order for purposes of illustration and discussion, the methods of the present disclosure are not limited to the particularly illustrated order or arrangement. The various steps of the methods 600, 800, 900, 1000, 1100, 1200, 1300, and 1400 can be omitted, rearranged, combined, and/or adapted in various ways without deviating from the scope of the present disclosure.

Example embodiments of the present disclosure relate to special effects for a text source, such as a traditional paper book, e-book, website, mobile phone text, comic book, or any other form of pre-defined text, and an associated method and system for playing the special effects. In particular, the special effects may be played in response to a user reading the text source to enhance the enjoyment of their reading experience. The special effects can be customized to the particular text source and can be synchronized to initiate the special effect in response to the text source being read.

In one aspect, a system for providing a special effect associated with an auditory input, can include an electronic mobile device configured to: receive an audible input from a user comprising speech of a user reading one or more portions of a text source; determine whether the audible input matches one or more pre-determined triggers via a speech recognition algorithm; and in response to determining that the audible input matches the pre-determined trigger, command a special effect device to output a plurality of special effects associated with the text source. The special effect device can include an audio speaker and a light source, and the at least one of the one or more special effects can include audio content and light emission. The plurality of special effects can include a first special effect and a second special effect, wherein the first special effect and the second special effect are different, and wherein the electronic mobile device is configured to command the special effect output device to output the second special effect at least partially concurrently with outputting the first special effect.

In some embodiments, the text source is pre-existing.

In some embodiments, the text source comprises a book.

In some embodiments, the text source comprises a comic book.

In some embodiments, the text source comprises a printed text source.

In some embodiments, the text source comprises an electronically displayed text source.

In some embodiments, the electronic mobile device is configured to command the special effect device to begin outputting the first special effect before beginning to output the second special effect.

In some embodiments, the electronic mobile device is configured to command the special effect device to stop outputting the first special effect before stopping the output of the second special effect.

In some embodiments, wherein the electronic mobile device is configured to command the special effect device to stop outputting the second special effect before stopping the output of the first special effect.

In some embodiments, wherein the plurality of special effects comprises a first special effect comprising an audio output, a second special effect comprising an audio output, and a third special effect comprising a light emission.

In some embodiments, wherein a first pre-determined trigger causes output of the first special effect and a second pre-determined trigger causes output of the second special effect, wherein the first pre-determined trigger is different than the second pre-determined trigger; and wherein the electronic mobile device is configured to determine when a pre-determined trigger phrase is detected via a speech recognition algorithm at least partly concurrently while outputting the plurality of special effects.

In some embodiments, the electronic mobile device is communicably coupled but physically distinct from at least one of the one or more special effect devices.

In some embodiments, wherein at least one of the plurality of special effects comprises animation.

In some embodiments, at least one of the plurality of special effects comprises video.

In some embodiments, at least one of the plurality of special effects comprises a picture.

In some embodiments, the one or more pre-determined triggers comprise active pre-determined triggers and inactive pre-determined triggers; and in response to determining that the audible input matches an active pre-determined trigger command the system to activate an inactive pre-determined trigger; and, in response to determining that the audible input matches the activated pre-determined trigger, command the special effect device to output one or more special effects.

In some embodiments, the electronic mobile device is configured to deactivate at least one of the active pre-determined trigger phrases after detection of the at least one of the plurality of pre-determined trigger phrases such that a user subsequently reading the at least one of the plurality of pre-determined trigger phrases after detection of the at least one of the plurality of pre-determined trigger phrases does not result in commanding the special effect output device to output a special effect.

In some embodiments, the audible input from a user comprising speech of a user reading one or more portions of a text source is pre-recorded and electronically outputted.

In another aspect, a system for providing a special effect associated with an auditory input, can include an electronic mobile device configured to: receive an audible input from a user comprising speech of a user reading one or more portions of a text source; determine whether the audible input matches one or more pre-determined triggers via a speech recognition algorithm. The one or more pre-determined triggers can comprise active pre-determined triggers and inactive pre-determined triggers. In response to determining that the audible input matches at least one of the one or more pre-determined triggers, the electronic mobile device can be configured to: command one or more special effect devices to output a plurality of special effects associated with the text source and in response to determining that the audible input matches an active pre-determined trigger command the system to activate an inactive pre-determined trigger. The one or more special effect devices can comprise an audio speaker and a light source, and the at least one of the one or more special effects includes audio content and light emission.

The plurality of special effects can comprise a first special effect comprising an audio output, a second special effect comprising an audio output different from the first special effect, and a third special effect comprising a light emission. The electronic mobile device can be configured to command the special effect output device to output the second special effect and/or the third special effect at least partially concurrently with outputting the first special effect. A first pre-determined trigger can cause output of the first special effect and a second pre-determined trigger can cause output of the second special effect and a third pre-determined trigger can cause output of the third special effect, wherein the first pre-determined trigger is at least partly different than the second pre-determined trigger. The electronic mobile device can be configured to determine when a pre-determined trigger phrase is detected via a speech recognition algorithm at least partly concurrently while outputting the plurality of special effects.

In yet another aspect, a system for providing a special effect associated with an auditory input can include an electronic mobile device configured to: receive an audible input from a user comprising speech of a user reading one or more portions of a text source, wherein the text source comprises a printed book; determine whether the audible input matches one or more pre-determined triggers via a speech recognition algorithm; and in response to determining that the audible input matches the pre-determined trigger, command one or more special effect devices to output a plurality of special effects associated with the text source.

The one or more special effect device can include an audio speaker and a light source, and the at least one of the one or more special effects can include audio content and light emission. The plurality of special effects can include a first special effect comprising an audio output, a second special effect comprising an audio output different from the first special effect, and a third special effect comprising a light emission. The electronic mobile device can be configured to command the special effect output device to output the second special effect and/or the third special effect at least partially concurrently with outputting the first special effect. A first pre-determined trigger can cause output of the first special effect and a second pre-determined trigger can cause output of the second special effect and a third pre-determined trigger can cause output of the third special effect. The first pre-determined trigger can be at least partly different than the second pre-determined trigger. The electronic mobile device can be configured to determine when a pre-determined trigger phrase is detected via a speech recognition algorithm at least partly concurrently while outputting the plurality of special effects.

Further, it should be recognized that the embodiments disclosed can be used and implemented with various text sources and/or integrated with other systems to develop new text sources (such as new games, scripts or speeches) or to modify existing text sources (such as including new instructing in a game manual describing the features of the speech recognition device.) Thus the embodiments of the disclosure should not be held as constrained only to existing text sources or special effects.

What is claimed is:

1. A computing system, comprising:
one or more processors;
a speech recognition system implemented by the one or more processors; and
one or more non-transitory computer-readable media that store instructions that when executed by the one or more processors cause the computing system to perform operations, the operations comprising:
determining a current position of a speaker within a text source that comprises a plurality of phrases;
identifying a set of expected phrases expected to be uttered by the speaker based at least in part on the current position of the speaker within the text source, wherein the set of expected phrases is a subset of the plurality of phrases included in the text source;
obtaining audio data descriptive of a human speech utterance;
recognizing, by the speech recognition system, the human speech utterance based at least in part on the audio data, wherein an output of the speech recognition system is biased toward the set of expected phrases; and
determining whether to cause occurrence of a special effect based at least in part on the output of the speech recognition system.

2. The computing system of claim 1, wherein recognizing, by the speech recognition system, the human speech utterance comprises:
generating, by the speech recognition system, an initial output comprising a plurality of hypothesized phrases; and
selecting one of the plurality of hypothesized phrases based at least in part on the set of expected phrases.

3. The computing system of claim 2, wherein selecting one of the plurality of hypothesized phrases based at least in part on the set of expected phrases comprises selecting a first hypothesized phrase that is included in the set of expected phrases.

4. The computing system of claim 2, wherein:
the initial output from the speech recognition system further comprises a plurality of confidence scores respectively associated with the plurality of hypothesized phrases; and
selecting one of the plurality of hypothesized phrases based at least in part on the set of expected phrases comprises:
identifying a subset of the hypothesized phrases that are included in the set of expected phrases; and
selecting the hypothesized phrase that has the largest confidence score in the subset of the hypothesized phrases.

5. The computing system of claim 1, wherein recognizing, by the speech recognition system, the human speech utterance comprises:
generating, by the speech recognition system, an initial output comprising a plurality of hypothesized phrases and a plurality of confidence scores respectively associated with the plurality of hypothesized phrases;
increasing the confidence score of any hypothesized phrase that is included in the set of expected phrases; and
after increasing the confidence score of any hypothesized phrase that is included in the set of expected phrases, selecting the hypothesized phrase that has the largest confidence score.

6. The computing system of claim 1, wherein:
the speech recognition system comprises a machine-learned speech recognition model that has been trained to preferentially recognize speech utterances in audio data that match a set of input text provided to the machine-learned speech recognition model at an inference time at which the machine-learned speech recognition model recognizes the speech utterances; and
recognizing, by the speech recognition system, the human speech utterance comprises:
inputting the audio data into a machine-learned speech recognition model; and
providing the set of expected phrases as an additional input to the machine-learned speech recognition model.

7. The computing system of claim 1, wherein:
the set of expected phrases consists of a next word expected to be uttered by the speaker; and
the output of the speech recognition system is biased toward the next word.

8. The computing system of claim 1, wherein:
the set of expected phrases consists of a set of phrases included on a same page as the current position of the speaker; and
the output of the speech recognition system is biased toward the set of phrases included on the same page as the current position of the speaker.

9. The computing system of claim 1, wherein the computing system consists of an electronic mobile device.

10. A computer-implemented method, comprising:
determining, by one or more computing devices, a current position of a speaker within a text source that comprises a plurality of phrases;
identifying, by the one or more computing devices, a set of expected phrases expected to be uttered by the speaker based at least in part on the current position of the speaker within the text source, wherein the set of expected phrases is a subset of the plurality of phrases included in the text source;
obtaining, by the one or more computing devices, audio data descriptive of a human speech utterance;
performing, by the one or more computing devices, one or more speech recognition techniques to recognize the human speech utterance, wherein performing, by the one or more computing devices, the one or more speech recognition techniques to recognize the human speech utterance comprises biasing, by the one or more computing devices, an output of the one or more speech recognition techniques toward the set of expected phrases; and
determining, by the one or more computing devices, whether to cause occurrence of a special effect based at least in part on the output of the one or more speech recognition techniques.

11. The computer-implemented method of claim 10, wherein biasing, by the one or more computing devices, the output of the one or more speech recognition techniques toward the set of expected phrases comprises:
receiving, by the one or more computing devices, an initial output from the one or more speech recognition techniques, wherein the initial output comprises a plurality of hypothesized phrases; and
selecting, by the one or more computing devices, one of the plurality of hypothesized phrases based at least in part on the set of expected phrases.

12. The computer-implemented method of claim 11, wherein selecting, by the one or more computing devices, one of the plurality of hypothesized phrases based at least in part on the set of expected phrases comprises selecting, by the one or more computing devices, a first hypothesized phrase that is included in the set of expected phrases.

13. The computer-implemented method of claim 11, wherein:
the initial output from the one or more speech recognition techniques further comprises a plurality of confidence scores respectively associated with the plurality of hypothesized phrases; and
selecting, by the one or more computing devices, one of the plurality of hypothesized phrases based at least in part on the set of expected phrases comprises:
identifying, by the one or more computing devices, a subset of the hypothesized phrases that are included in the set of expected phrases; and
selecting, by the one or more computing devices, the hypothesized phrase that has the largest confidence score in the subset of the hypothesized phrases.

14. The computer-implemented method of claim 10, wherein biasing, by the one or more computing devices, the output of the one or more speech recognition techniques toward the set of expected phrases comprises:
receiving, by the one or more computing devices, an initial output from the one or more speech recognition techniques, wherein the initial output comprises a plurality of hypothesized phrases and a plurality of confidence scores respectively associated with the plurality of hypothesized phrases;
increasing, by the one or more computing devices, the confidence score of any hypothesized phrase that is included in the set of expected phrases; and
after increasing, by the one or more computing devices, the confidence score of any hypothesized phrase that is included in the set of expected phrases, selecting, by the one or more computing devices, the hypothesized phrase that has the largest confidence score.

15. The computer-implemented method of claim 10, wherein:
performing, by the one or more computing devices, the one or more speech recognition techniques to recognize the human speech utterance comprises inputting, by the one or more computing devices, the audio data into a machine-learned speech recognition model; and
biasing, by the one or more computing devices, the output of the one or more speech recognition techniques toward the set of expected phrases comprises providing, by the one or more computing devices, the set of expected phrases as an additional input to the machine-learned speech recognition model.

16. The computer-implemented method of claim 15, wherein the machine-learned speech recognition model has been trained to preferentially recognize speech utterances in audio data that match a set of input text provided to the machine-learned speech recognition model at an inference time at which the machine-learned speech recognition model recognizes the speech utterances.

17. The computer-implemented method of claim 10, wherein:
identifying, by the one or more computing devices, the set of expected phrases expected to be uttered by the speaker based at least in part on the current position of the speaker within the text source comprises identifying, by the one or more computing devices, a next word expected to be uttered by the speaker based at least in part on the current position of the speaker; and
biasing, by the one or more computing devices, the output of the one or more speech recognition techniques toward the set of expected phrases comprises biasing, by the one or more computing devices, the output of the one or more speech recognition techniques toward the next word.

18. The computer-implemented method of claim 10, wherein:
identifying, by the one or more computing devices, the set of expected phrases expected to be uttered by the speaker based at least in part on the current position of the speaker within the text source comprises identifying, by the one or more computing devices, a set of phrases included on a same page as the current position of the speaker; and
biasing, by the one or more computing devices, the output of the one or more speech recognition techniques toward the set of expected phrases comprises biasing, by the one or more computing devices, the output of the one or more speech recognition techniques toward the set of phrases included on the same page as the current position of the speaker.

19. The computer-implemented method of claim 10, further comprising:
activating, by the one or more computing devices, acoustic echo prevention within attenuating an associated audio output.

20. One or more non-transitory computer-readable media that store instructions that when executed by one or more processors cause the one or more processor to perform operations, the operations comprising:
determining a current position of a speaker within a text source that comprises a plurality of phrases;
identifying a set of expected phrases expected to be uttered by the speaker based at least in part on the current position of the speaker within the text source, wherein the set of expected phrases is a subset of the plurality of phrases included in the text source;
obtaining audio data descriptive of a human speech utterance;
performing one or more speech recognition techniques to recognize the human speech utterance, wherein performing, by the one or more computing devices, the one or more speech recognition techniques to recognize the human speech utterance comprises biasing, by the one or more computing devices, an output of the one or more speech recognition techniques toward the set of expected phrases; and
determining whether to cause occurrence of a special effect based at least in part on the output of the one or more speech recognition techniques.

21. A computing system, comprising:
one or more processors; and
one or more non-transitory computer-readable media that store instructions that when executed by the one or more processors cause the computing system to perform operations, the operations comprising:
obtaining audio data descriptive of a human speech utterance uttered by a speaker;
performing a position-based tracking technique that tracks a current position of the speaker within a text source;
performing a keyword spotting technique in parallel with the position-based tracking technique; and
determining whether to cause occurrence of a special effect based at least in part on a first output of the position-based tracking technique or a second output of the keyword spotting technique.

22. The computing system of claim 21, wherein performing the position-based tracking technique that tracks the current position of the speaker within the text source comprises:
obtaining a script for the text source, wherein the script provides a plurality of phrases included in the text source and a plurality of positions respectively associated with the plurality of phrases;
recognizing a first phrase within the audio data descriptive of the human speech utterance; and
updating the current position of the speaker to a first position associated with the recognized first phrase in the script.

23. The computing system of claim 21, wherein performing the keyword spotting technique comprises:
recognizing a first phrase within the audio data descriptive of the human speech utterance; and
comparing the first phrase to a set of keywords to determine if the first phrase matches any of the set of keywords.

24. The computing system of claim 23, wherein the set of keywords is associated with and specific to a range of positions that includes the current position of the speaker.

25. The computing system of claim 21 wherein the computing system is configured to perform said keyword spotting technique in parallel with the position-based tracking technique only when the current position of the speaker is within a predefined range of positions.

26. The computing system of claim 21, wherein the computing system is configured to cease performing said keyword spotting technique when the current position of the speaker is outside of a predefined range of positions.

27. The computing system of claim 21, wherein determining whether to cause occurrence of the special effect based at least in part on the first output of the position-based tracking technique or the second output of the keyword spotting technique comprises causing occurrence of the special effect if either of the first output or the second output indicate that the special effect should occur.

28. The computing system of claim 21, wherein determining whether to cause occurrence of the special effect based at least in part on the first output of the position-based tracking technique or the second output of the keyword spotting technique comprises causing occurrence of the special effect if both of the first output or the second output indicate that the special effect should occur.
